(19) United States
(12) Patent Application Publication
(10) Pub. No.: US 2025/0341682 A1
(43) Pub. Date: Nov. 6, 2025

(54) HOLDER FOR AN OPTICAL COMPONENT

(71) Applicant: CommScope Technologies LLC, Hickory, NC (US)

(72) Inventors: Bart Mattie CLAESSENS, Hasselt (BE); Geert VAN GENECHTEN, Vorselaar (BE); Johan GEENS, Bunsbeek (BE); Bart VOS, Geel (BE)

(73) Assignee: CommScope Technologies LLC, Hickory, NC (US)

(21) Appl. No.: 18/855,426

(22) PCT Filed: Apr. 14, 2023
(86) PCT No.: PCT/US2023/018692

§ 371 Date: Oct. 9, 2024

Related U.S. Application Data
(60) Provisional application No. 63/331,006, filed on Apr. 14, 2022.
(60) Provisional application No. 63/416,198, filed on Oct. 14, 2022.
(60) Provisional application No. 63/459,019, filed on Apr. 13, 2023.

(51) Int. Cl. G02B 6/36; G02B 6/44

(52) U.S. Cl. CPC G02B 6/3616; G02B 6/4453

(57) ABSTRACT

The present disclosure relates to a holder for attaching an optical component to a structure such as a tray. The holder includes integrated first mounting features including end tabs and integrated second mounting features including dovetail projections.

### CROSS-REFERENCE TO RELATED APPLICATIONS

This application is being filed on Apr. 14, 2023 as a PCT International Patent Application and claims the benefit of U.S. Patent Application Ser. No. 63/331,006, filed Apr. 14, 2022, U.S. Patent Application Ser. No. 63/416,198, filed Oct. 14, 2022, and U.S. Patent Application Ser. No. 63/459,019, filed Apr. 13, 2023, the disclosures of which are incorporated herein by reference in their entirety.

### TECHNICAL FIELD

The present disclosure relates generally to holders for securing optical components such as optical splice holders, passive optical splitter modules, optical tap modules and wavelength division multiplexer modules to structures such as trays, enclosures or panels.

### BACKGROUND

In the telecommunications industry, component holders are used to secure components such as optical splice holders, passive optical splitter modules, optical tapping modules, and wavelength division multiplexer modules to structures such as trays, panels and enclosures. Currently, a variety of different styles of attachment arrangements are provided on structures such as trays, panels and enclosures for facilitating securing component holders thereto. For example, FIG. 1 depicts a prior art tray 20 having a plurality of attachment features 22 for securing component holders to the tray 20. Each of the attachment features 22 includes a pair of aligned grooves 24 each having a dovetail shaped cross-section. FIG. 2 depicts another prior art tray 30 having holder attachment arrangements 32 including semi-circular receptacles 34 provided at a recessed region 36 of the tray 30. Because different styles of holder attachment arrangements are provided on trays, enclosures and panels, service providers can be required to stock different types of component holders having different types of mounting features compatible with the different holder attachment arrangements that may be encountered in the field.

### SUMMARY

One aspect of the present disclosure relates to a plate-style holder for holding an optical component. The holder has a top side at which an optical component holder can be secured (e.g. by latching, fasteners or other means). Different mounting features compatible with different styles of holder attachment arrangements are integrated with the holder. For example, dovetail projections can also be provided adjacent a bottom of the holder. The dovetail projections can provide a first type of connection structure compatible with a first holder attachment arrangement. Also, by way of example, mounting tabs can be provided at opposite ends of the holder. The mounting tabs can be resiliently movable in an orientation along a length of the holder. The mounting tabs can provide a second type of connection structure compatible with a second holder attachment arrangement. In certain examples, the dovetail projections can be integrated with one or more resilient features (e.g., a cantilever or cantilevers) that allow the dovetail projections to be moved relative to the holder in a direction corresponding to a depth or a thickness of the holder. In one example, the dovetail projections are resiliently movable relative to the holder between an elevated position in which the dovetail projections are positioned at the same level or higher than the mounting tabs and a depressed position in which the dovetail projections are positioned lower than the mounting tabs. In certain examples, the elevated position is in at rest position. By elevating the dovetail projections, the dovetail projections do not interfere with connecting the holder to a tray such as the tray having the second attachment arrangements. Additionally, if it is desired to mount the holder to a tray such as the tray having the first attachment arrangements, the dovetail projections can be flexed to the depressed position so as to be capable of being inserted into the dovetail grooves of the attachment arrangements.

Another aspect of the present disclosure relates to a holder for an optical component. The holder includes a holder body having a mounting location at which the optical component can be secured. The holder body has a length, a width, and a depth. The length extends between first and second ends of the holder body. The holder body also includes first and second sides that extend between the first and second ends. The width is defined between the first and second sides. The depth is perpendicular with respect to the length and the width. The holder includes first and second mounting tabs located at the first and second ends of the holder body. The mounting tabs are resiliently movable relative to the holder body in a first orientation along the length of the holder body. The holder also includes first and second dovetail projections resiliently movable relative to the holder body in a second orientation along the depth of the holder body.

Another aspect of the present disclosure relates to an optical component holder having an envelope-style configuration in which an optical component can be laterally loaded into the holder through a side opening. The holder can include first and second major sides defined by opposite first and second major walls which cooperate to define at least a portion of the pocket. The major walls can extend along a length of the holder between opposite first and second ends. First and second mounting tabs are located at the first and second ends adjacent the first major side. The first and second mounting tabs are resiliently movable relative to the holder body in an orientation along the length of the holder body. First and second dovetail projections are provided at the second major side of the holder body.

Another aspect of the present disclosure relates to a holder for an optical component that includes a holder body having a pocket at which the optical component can be secured. The holder body has a length, a width, and a depth. The length extends between first and second ends of the holder body. The holder body includes first and second main walls that oppose one another and that extend between the first and second ends. The pocket is defined between the first and second main walls. The width is defined between first and second sides of the holder body that extend between the first and second ends of the holder body. The first side includes a sidewall that interconnects the first and second main walls. The second side has an open configuration suitable for allowing the optical component to be inserted into the pocket through the second side. The first main wall defines a first major outer side of the holder body and the second main wall defines an opposite second major outer side of the holder body. The depth is perpendicular with respect to the length and the width of the holder body and extends between the first and second major outer sides of the holder body. The holder also includes first and second mounting tabs located at the first and second ends of the holder body adjacent the first major outer side of the holder. The first and second mounting tabs are resiliently movable relative to the holder body along the length of the holder body. The holder further includes first and second dovetail projections that project outwardly from the second major outer side of the holder body.

In one embodiment, the fiber optic component holders of the present disclosure include four dovetail projections. In one embodiment, two dovetail projections are respectively integrated with a first resilient beam member, extending along the length of the holder body between two base ends, the two base ends each being attached to the holder body. Two beam members can be provided in one example. In one embodiment, the body of the component holder includes an upper and a lower portion. The lower portion is stepped downward from the upper portion by a distance along the depth of the holder body. In some examples, the dovetail projections are integrated with the lower portion and the first and second mounting tabs are integrated with the upper portion. The lower portion is removable from the upper portion in some examples.

Another aspect of the present disclosure relates to a holder for an optical component, including a holder body including one or more first mounting features for selective securement of the holder body to an optical tray and a mounting location at which the optical component can be secured, the holder body further defining an aperture, and a rotation dovetail plate including one or more second mounting features for selective securement of the rotation dovetail plate to an optical tray, wherein the rotation dovetail plate is keyed to reside within the aperture of the holder body in one of at least a first orientation and a second orientation, wherein the first orientation is substantially perpendicular to the second orientation.

In one embodiment, a top perimeter of the aperture of the holder body is larger than a bottom perimeter of the aperture body to inhibit passage of the rotation dovetail plate entirely through the aperture. In one embodiment, the rotation dovetail plate is selectively securable to the upper portion with one or more snaps. In one embodiment, one or more first mounting features are in the form of at least one or more semicircular or curved tabs. In one embodiment, one or more first mounting features are operably coupled to respective end beams to enable the one or more first mounting features to resiliently flex relative to other portions of the holder body.

In one embodiment, the one or more second mounting features are in the form of one or more dovetail projections extending from a bottom side of the rotation dovetail plate. In one embodiment, the rotation dovetail plate further defines one or more stop structures to aid in securing of the rotation dovetail plate to a tray. In one embodiment, the rotation dovetail plate includes at least four perpendicular sides substantially equal in length, with at least two of the sides defining keyed tabs configured to reside within the aperture of the holder body. In one embodiment, the holder body further defines a latching portion for selective coupling to an optical component.

Another aspect of the present disclosure relates to an assembly for securement of an optical component including a tray selectively couplable to a housing, a holder body including one or more first mounting features for selective securement of the holder body to the tray and a mounting location at which the optical component can be secured, the holder body further defining an aperture, and a rotation dovetail plate including one or more second mounting features for selective securement of the rotation dovetail plate to an optical tray, wherein the rotation dovetail plate is keyed to reside within the aperture of the holder body in one of at least a first orientation and a second orientation, wherein the first orientation is substantially perpendicular to the second orientation.

In one embodiment, a top perimeter of the aperture of the holder body is larger than a bottom perimeter of the aperture body to inhibit passage of the rotation dovetail plate entirely through the aperture. In one embodiment, the rotation dovetail plate is selectively securable to the upper portion with one or more snaps. In one embodiment, the one or more first mounting features are in the form of one or more semicircular or curved tabs. In one embodiment, the one or more second mounting features are in the form of one or more dovetail projections extending from a bottom side of the rotation dovetail plate.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

FIG. 1 is a perspective view of a first prior art tray having first attachment arrangements for affixing optical component holders to the tray;

FIG. 2 is a perspective view of a second prior art tray having second attachment arrangements for affixing optical component holders to the tray;

FIG. 3 is a perspective view showing a top side of an optical component holder in accordance with the principles of the present disclosure that includes mounting features that are compatible with the different attachment arrangements provided by the trays depicted at FIGS. 1 and 2;

FIG. 4 is a perspective view depicting a bottom a side of the optical component holder of FIG. 3;

FIG. 5 is a bottom view of the optical component holder of FIG. 3;

FIG. 6 is a top view of the optical component holder of FIG. 3;

FIG. 7 is a side view of the optical component holder of FIG. 3;

FIG. 8 is an end view of the optical component holder of FIG. 3;

FIG. 9 is a cross-sectional view taken along section line 9-9 of FIG. 6;

FIG. 10 is a cross-sectional view taken along section line 10-10 with a resilient cantilever of the component holder in an elevated state in which the resilient cantilever is at rest (i.e. not flexed);

FIG. 11 is a cross-sectional view along section 10-10 of FIG. 6 showing the resilient cantilever of FIG. 10 moved to a depressed position in which the resilient cantilever is resiliently flexed in a downward direction from the elevated state;

FIG. 12 is a perspective view depicting two of the component holders of FIG. 3 secured to the tray of FIG. 1;

FIG. 13 is a perspective view depicting one of the component holders of FIG. 3 secured to the tray of FIG. 2, an optical component is also shown mounted to the optical component holder;

FIG. 14 is a perspective view depicting a top side of another optical component holder in accordance with the principles of the present disclosure;

FIG. 15 is a perspective view depicting a bottom view of the optical component holder of FIG. 14;

FIG. 16 is a top view of the optical component holder of FIG. 14;

FIG. 17 is a bottom view of the optical component holder of FIG. 14;

FIG. 18 is a perspective view depicting a first major outer side of another optical component holder in accordance with the principles of the present disclosure;

FIG. 19 is a perspective view of the optical component holder of FIG. 18 depicting an opposite second major outer side of the optical component holder;

FIG. 20 is a plan view of the optical component holder of FIG. 18 depicting the first major outer side of the optical component holder;

FIG. 21 is a plan view of the optical component holder of FIG. 18 depicting the second major outer side of the optical component holder of FIG. 18;

FIG. 22 is a side view of the optical component holder of FIG. 19;

FIG. 23 is an end view of the optical component holder of FIG. 19;

FIG. 24 is a perspective top view of a third tray having attachment arrangements, similar to the attachment arrangements shown in FIG. 1, for affixing optical component holders to the tray;

FIG. 25 is a top view of the attachment arrangements of FIG. 24;

FIG. 26 is a perspective view showing a top side of an optical component holder in accordance with the principles of the present disclosure that includes mounting features that are compatible with the different attachment arrangements provided by the trays depicted at FIGS. 2 and 24;

FIG. 27 is a perspective view depicting a bottom a side of the optical component holder of FIG. 26;

FIG. 28 is a top view of the optical component holder of FIG. 26;

FIG. 29 is a bottom view of the optical component holder of FIG. 26;

FIG. 30 is an end view of the optical component holder of FIG. 26;

FIG. 31 is a side view of the optical component holder of FIG. 26;

FIG. 32 is a cross-sectional view taken along section line 32-32 with a beam member of the component holder of FIG. 26 shown;

FIG. 33 is the optical component holder of FIG. 26 holding an optical component and mounted to the tray of FIG. 24;

FIG. 34 is a perspective view showing a top side of an optical component holder in accordance with the principles of the present disclosure that includes mounting features that are compatible with the different attachment arrangements provided by the trays depicted at FIGS. 2 and 24;

FIG. 35 is a perspective view depicting a bottom a side of the optical component holder of FIG. 34;

FIG. 36 is a top view of the optical component holder of FIG. 34;

FIG. 37 is a bottom view of the optical component holder of FIG. 34;

FIG. 38 is a side view of the optical component holder of FIG. 34;

FIG. 39 is an end view of the optical component holder of FIG. 34;

FIG. 40 is a perspective view of the optical component holder of FIG. 34 with a bottom portion of a base removed; and

FIG. 41 is the optical component holder of FIG. 34 holding an optical component and mounted to the tray of FIG. 24.

FIG. 42 is a perspective view depicting a top side of an optical component holder, in accordance with the principles of the present disclosure that includes mounting features that are compatible with different attachment arrangements.

FIG. 43 is a perspective view depicting a bottom side of the optical component holder of FIG. 42.

FIG. 44 is a profile view depicting the optical component holder of FIG. 42.

FIG. 45 is a plan view depicting the optical component holder of FIG. 42.

FIG. 46 is a perspective view depicting the optical component holder of FIG. 42 with an upper portion separated from a lower portion, wherein the lower portion is rotatably engageable with the upper portion.

FIG. 47A is a perspective, cross-sectional view depicting optical component holder of FIG. 42, wherein a lower portion is positioned within an aperture of an upper portion of the optical component holder.

FIG. 47B is a perspective, cross-sectional view depicting optical component holder of FIG. 47A, wherein a lower portion is snap fit into the aperture of an upper portion of the optical component holder.

FIG. 48 is a perspective view depicting a top side of an optical component holder, in accordance with principles of the present disclosure that includes mounting features that are compatible with different attachment arrangements.

FIG. 49 is a perspective view depicting a bottom side of the optical component holder of FIG. 48.

FIG. 50 is a plan view depicting the optical component holder of FIG. 48.

FIG. 51 is a perspective view of a tray to which a first optical component holder is coupled in a first orientation, and a second optical component holder is coupled and a second orientation, wherein the first orientation is substantially perpendicular to the first orientation.

FIG. 52 is an exploded perspective view depicting a first optical component holder and optical component for coupling to a tray.

FIG. 53 is a plan view depicting an optical component holder with an upper portion separated from a lower portion, wherein the lower portion is engageable with the upper portion in two orientations.

FIG. 54 is a plan view depicting the optical component holder of FIG. 53, with the lower portion engaged with the upper portion.

FIG. 55 is a bottom plan view depicting the optical component holder of FIG. 53.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

Various embodiments of the present disclosure will be described in detail with reference to the drawings, where like reference numerals represent like parts and assemblies throughout the several views. Reference to various embodiments does not limit the scope of the invention, which is limited only by the scope of the claims attached hereto. Additionally, any example set forth in the specification is not intended to be limiting and merely sets forth some of the many possible embodiments for the claimed invention.

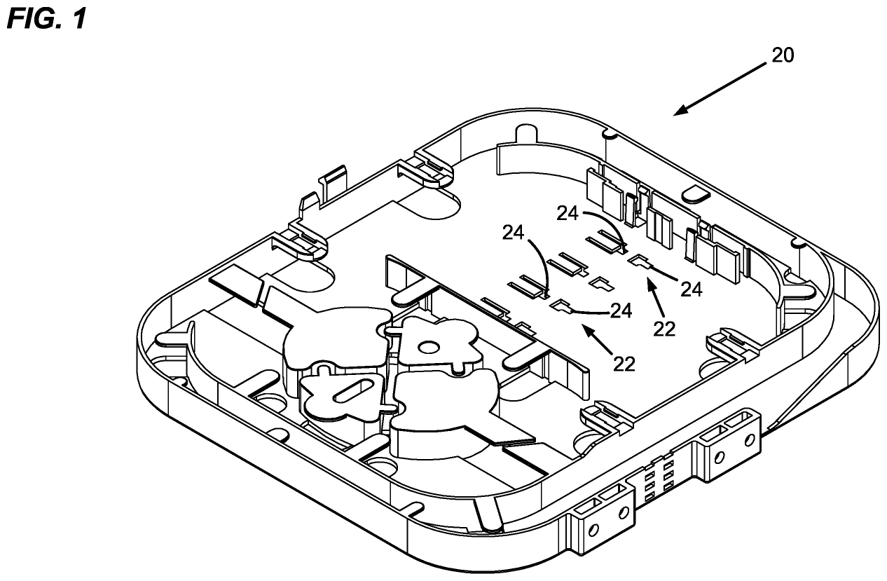

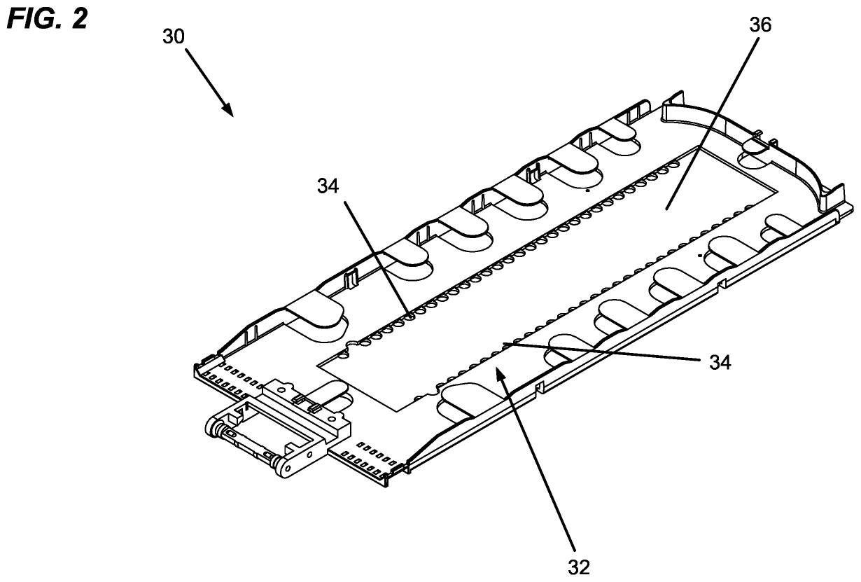

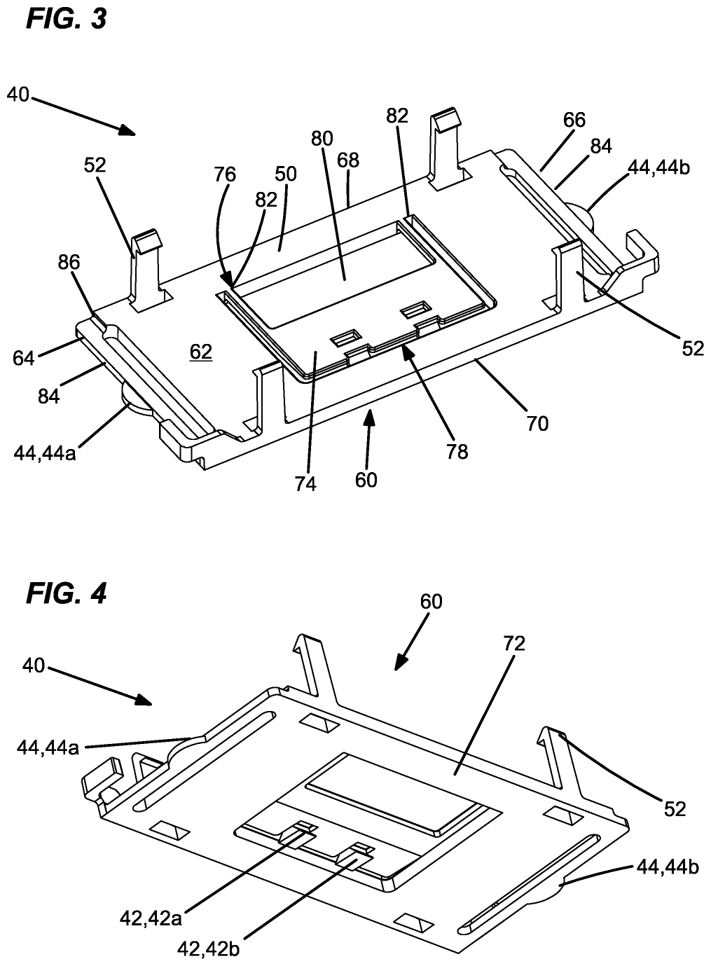

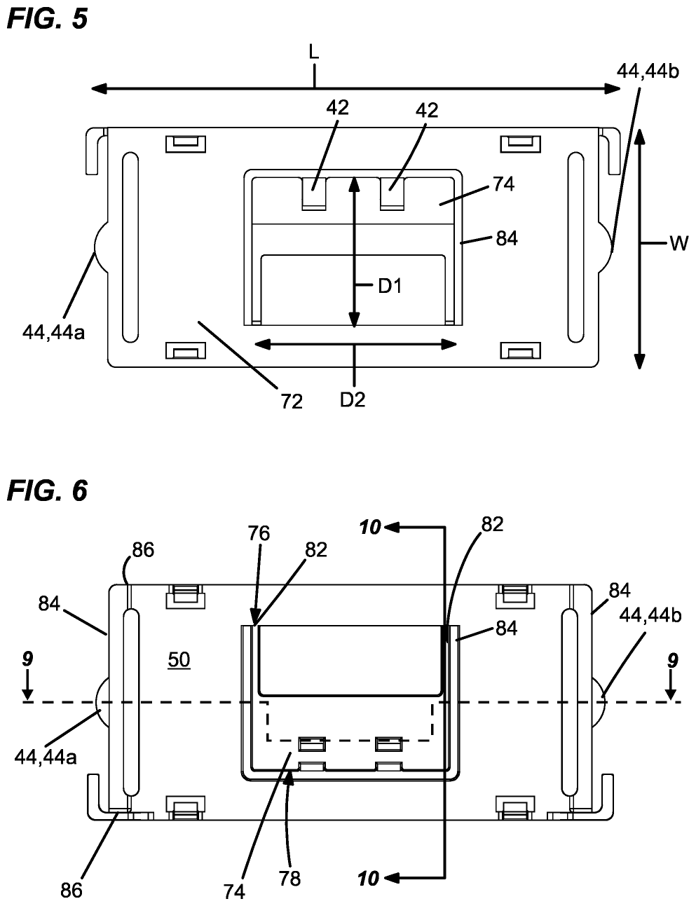

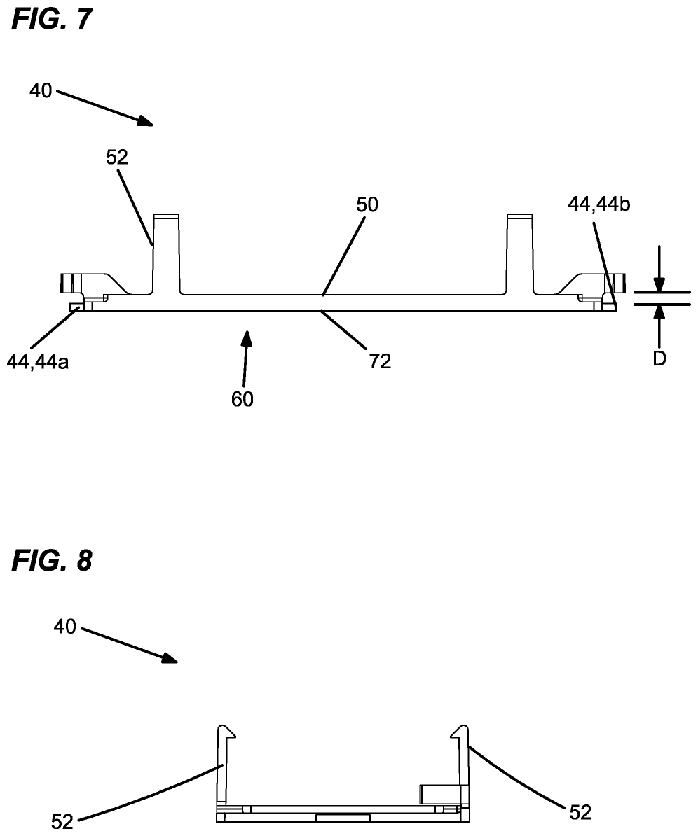

FIGS. 3-11 depict a first example of an optical component holder 40 in accordance with the principles of the present disclosure. The optical component holder 40 includes first mounting features depicted as dovetail projections 42 that are compatible with the attachment arrangements 22 of the tray of FIG. 1. For example, FIG. 12 shows two optical component holders 40 secured to the tray 20 by interlocks provided between the dovetail projections 42 of the holders 40 and the dovetail slots 24 of the attachment arrangements 22. The optical component holder 40 also includes second mounting features depicted as end tabs 44 that are compatible with the attachment arrangements 32 of the tray 30 of FIG. 2. For example, FIG. 13 depicts the optical component holder 40 secured to the tray 30 by an interlock between the end tabs 44 of the holder 40 and the receptacles 34 of one of the attachment arrangements 32 of the tray 30. It will be appreciated that the mounting features can also be referred to as mounting elements, mounting structures, connection features, connection elements, connection structures, attachment features, attachment elements, attachment structures, interlock features, interlock elements, interlock structures, or the like. Additionally, it will be appreciated that mounting features are compatible with a corresponding attachment arrangement if the mounting features and the attachment arrangement can interlock or otherwise engage one another to allow for mutual coupling. It will be appreciated that the holder 40 can also be mounted to additional structures such as panels and enclosures that can include corresponding attachment arrangements such as the arrangements 22, 32.

The optical component holder 40 of FIGS. 1-11 is depicted as a plate-style holder having a top side 50 at which an optical component can be secured. In the depicted example, latching arms 52 are provided for securing an optical component to the top side 50 of the optical component holder 40. Referring to FIG. 13, an example optical component 54 is secured to the top side 50 of the optical component holder 40 by the latching arms 52. It will be appreciated that the optical component 54 is representative of a variety of different types of optical components that may include, for example, components such as modules for securing fusion splices made between optical fibers, modules each containing one or more passive optical splitters, modules each containing at least one passible optical splitter, modules each containing at least one passive optical tap, and modules each containing at least one wavelength division multiplexer.

Referring to FIGS. 1-8, the optical component holder 40 includes a holder body 60 including a mounting location 62 at the top side 50 at which the optical component 54 can be secured (e.g. by the latching arms 52). The holder body has a length L a width W and a depth D. The length L extends between first and second ends 64, 66 of the holder body 60. The holder body 60 includes first and second sides 68, 70 that extend between the first and second ends 64, 66 of the holder body 60. The width W is defined between the first and second sides 68, 70 of the holder body 60. The depth D is perpendicular with respect to the length L and the width W and extends between the top side 50 and a bottom side 72 of the holder body 70. The top and bottom sides 50, 72 can also be referred to as first and second major sides of the holder body 70 and the first and second sides 68, 70 can also be referred to as minor sides of the holder 60.

The optical component holder 40 also includes first and second dovetail projections 42a, 42b that are movable relative to the holder body 60 in an orientation that extends along the depth D of the holder body 60 (e.g., the dovetail projections 42a, 42b are movable in an upward/downward direction). In the depicted example, the first and second dovetail projections 42a, 42b are both integrated with a single resilient cantilever member 74 having a base end 76 and a free end 78. In a preferred example, the dovetail projections 42a, 42b are unitarily formed with the cantilever member 74. The base end 76 of the cantilever member 74 is attached to the holder body 60. In one example, the base end 76 is unitarily formed with the holder 60. As shown at FIG. 3, the resilient cantilever member 74 defines an opening 80 adjacent to the base end 76 such that the base end 76 includes two spaced-apart connection points 82 at which the base end 76 is unitarily attached to the holder body 60 so as to be integrated with the holder body 60. In the depicted example, the holder body 60 is figured as a mounting plate, and the resilient cantilever member 74 is located at a central region of the mounting plate. The resilient cantilever member 74 is located within an opening 85 of the holder body 60 that extends through the depth D of the holder body 60.

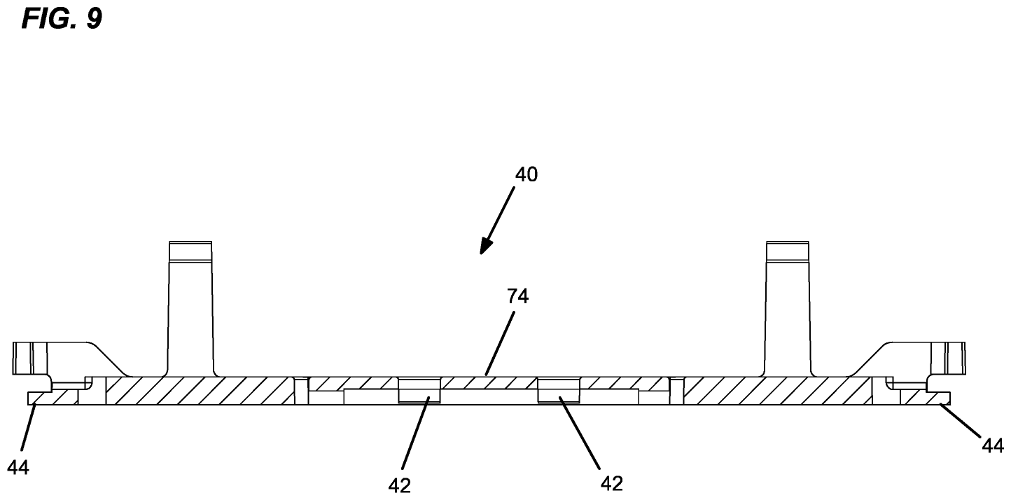

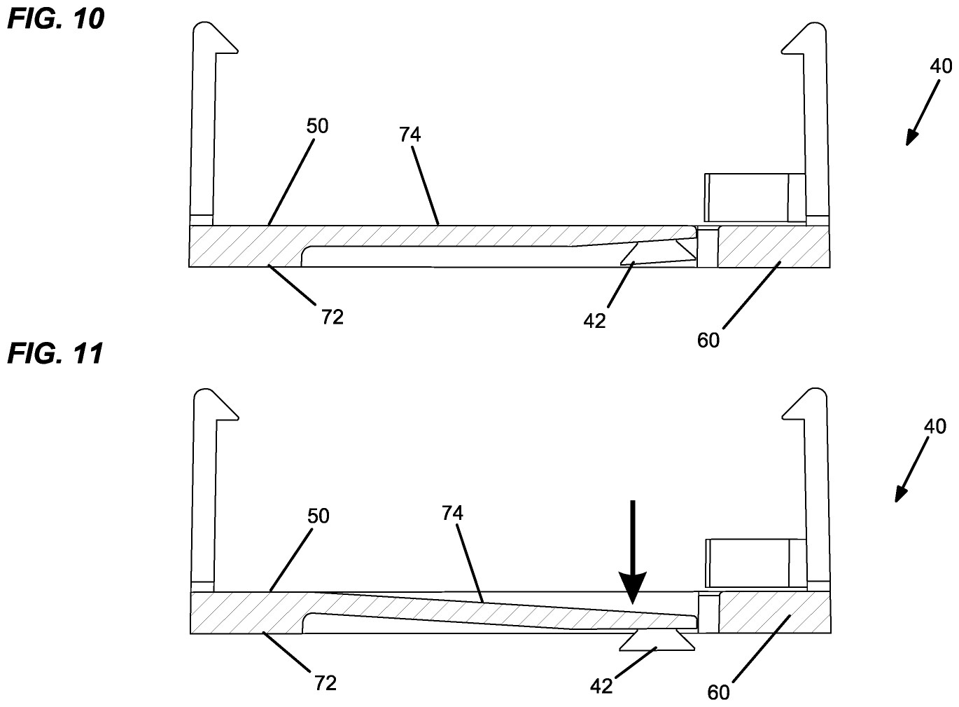

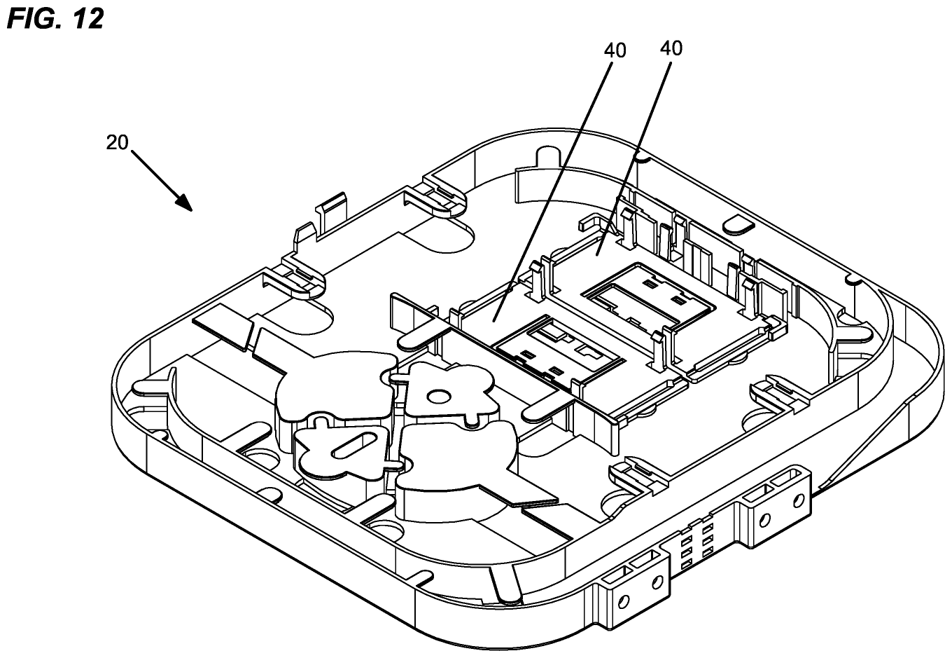

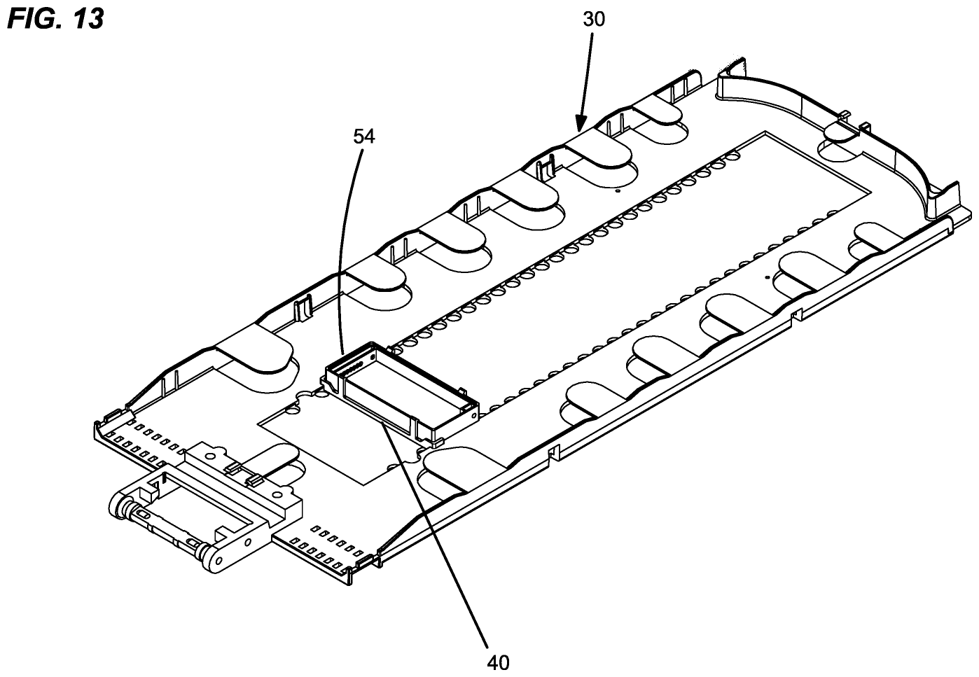

It will be appreciated that the resilient nature of the cantilever member 74 allows the first and second dovetail projections 42a, 42b to be moved relative to the holder body 60 between an elevated position (see FIGS. 9 and 10) and a depressed position (see FIG. 11) when the first and second dovetail projections 42a, 42b are positioned at the elevated position, the dovetail projections 42a, 42b are positioned at the same level or higher than the end tabs 44 of the optical component holder 40. When the dovetail projections 42a, 42b are in the depressed position of FIG. 11, the dovetail projections 42a, 42b are positioned lower than the end tabs 44. It will be appreciated that the resilient nature of the cantilever member 74 allows the first and second dovetail projections 42a, 42b to be moved between the elevated and depressed positions. The resilient cantilever member 74 is in a non-flexed (e.g., at rest state) when the dovetail projections 42 are in the elevated position, and is in a downwardly flexed state when the first and second dovetail projections 42a, 42b are in the depressed position. When the first and second dovetail projections 42a, 42b are in the elevated position, the dovetail projections 42a, 42b are situated to not interfere with the ability to secure the optical component holder 40 to the second tray 30 using the end tabs 44. However, by flexing the cantilever member 74 downwardly to move the dovetail projections 42a, 42b to the depressed position, the dovetail projections 42a, 42b can be oriented to be readily received within the dovetail slots 24 of one of the attachment arrangements 22 of the tray 20 to provide attachment of the holder 40 to the tray 20. In an alternative example, the cantilever member 74 can be at an at rest state when the lower position such that the dovetail projections 42a, 42b can normally be in the lower position. With this type of arrangement, the cantilever member 74 will flex upwardly when one of the holders 40 is mounted to the second tray 30 such that the dovetail projections 42a, 42b do not interfere the ability of the end tabs 44 to fit within the corresponding receptacles 34 of a corresponding one of the attachment arrangements 32 of the tray 30.

The optical component holder 40 also includes first and second mounting tabs 44a, 44b located at the first and second ends 64, 66 of the holder body 60. The first and second mounting tabs 44a, 44b are resiliently movable relative to the holder body 60 in an orientation along the length L of the holder body 60. In one example, the tabs 44a, 44b are formed with semi-circular shapes, but other shapes could be used as well. In one example, the tabs 44a, 44b are connected to the holder body 60 by resilient end beams 84 that extend across the width W of the holder body 60. Each of the resilient end beams 84 has opposite ends 86 attached to the holder body 60. In a preferred example, the opposite ends 86 are unitarily formed with the holder body 60 such that the end beams 84 are attached to the holder body 60 by unitary connections.

In a preferred example, the optical component holder 40 has a plastic construction. In one example, the optical component holder 40 is formed through a molding process (e.g. injection molding), in which the entire optical component holder 40 (e.g. the holder body 60, the end beams 84, the end tabs 44, the latching arms 52, the resilient cantilever member 74 and the dovetail projections 42) are molded as a single, unitary piece (e.g., structure, part).

In certain examples, the resilient cantilever member 74 have a thickness that extends between a top side and a bottom side of the resilient cantilever member 74. The resilient cantilever member has a first dimension D1 that extends from the base end 76 to the free end 78. The first dimension D1 extends along the width W of the holder body 60. The first and second dovetail projections 42a, 42b are unitarily formed with the bottom side of the resilient cantilever member 74. The resilient cantilever member has a second dimension D2 that extends along the length L of the holder body 60. The second dimension D2 is longer than the first dimension D1. The first and second dovetail projections are spaced-apart along the second dimension D2.

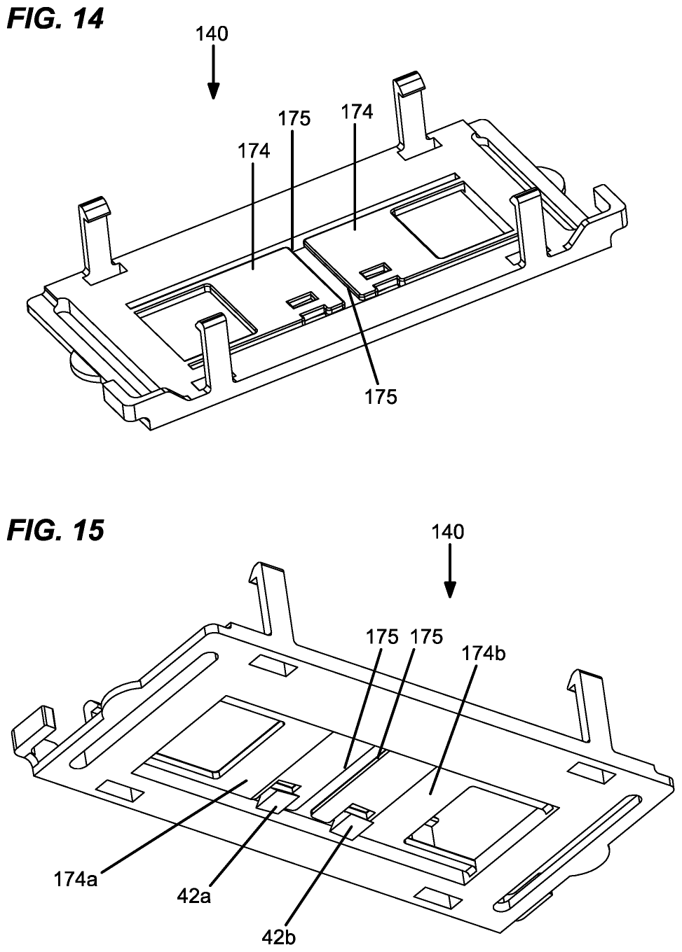

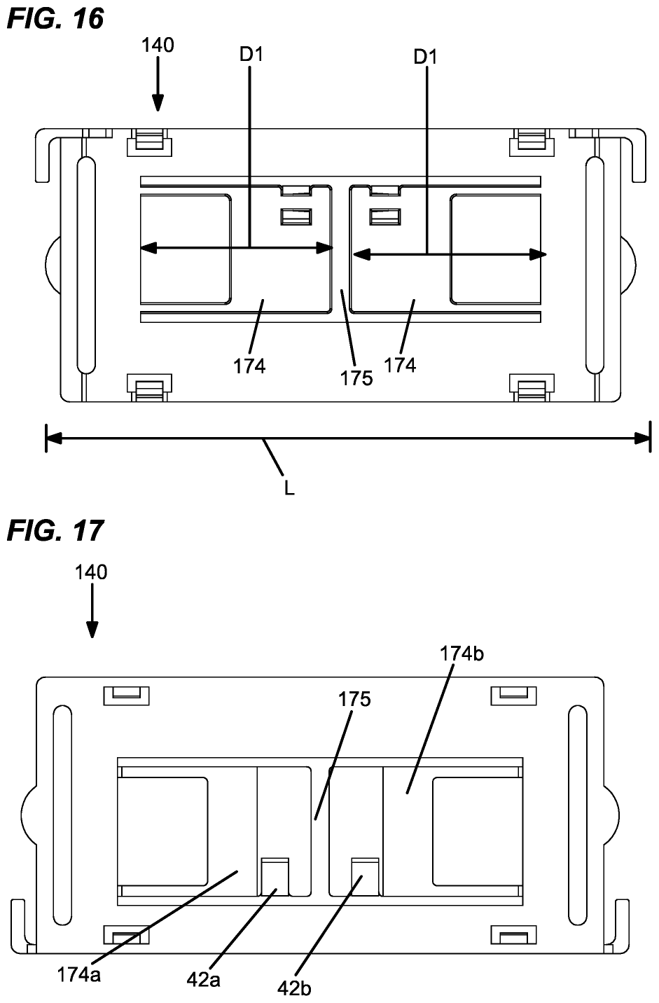

FIGS. 14-17 depict a second optical component holder 140 in accordance with the principles of the present disclosure. The optical component holder 140 has the same basic construction as the optical component holder 40, except the single cantilever member 74 has been replaced with two separate resilient cantilever members 174. The first dovetail projection 42a is integrated with one of the flexible cantilever members 174 and the second dovetail projection 42b is integrated with other resilient cantilever member 174. The cantilevers 174 include first and second cantilevers 174a, 174b having free ends 175 that oppose each other at a central region of the holder body of the optical component holder 140. The first and second cantilevers 174a, 174b have first dimensions D1 that extend from base ends to free ends of the first and second cantilever members 174a, 174b. The first dimensions D1 extend along the length L of the holder body 60 of the optical component holder 140. The first and second cantilever members 174a, 174b have lengths that extend along the first dimensions D1.

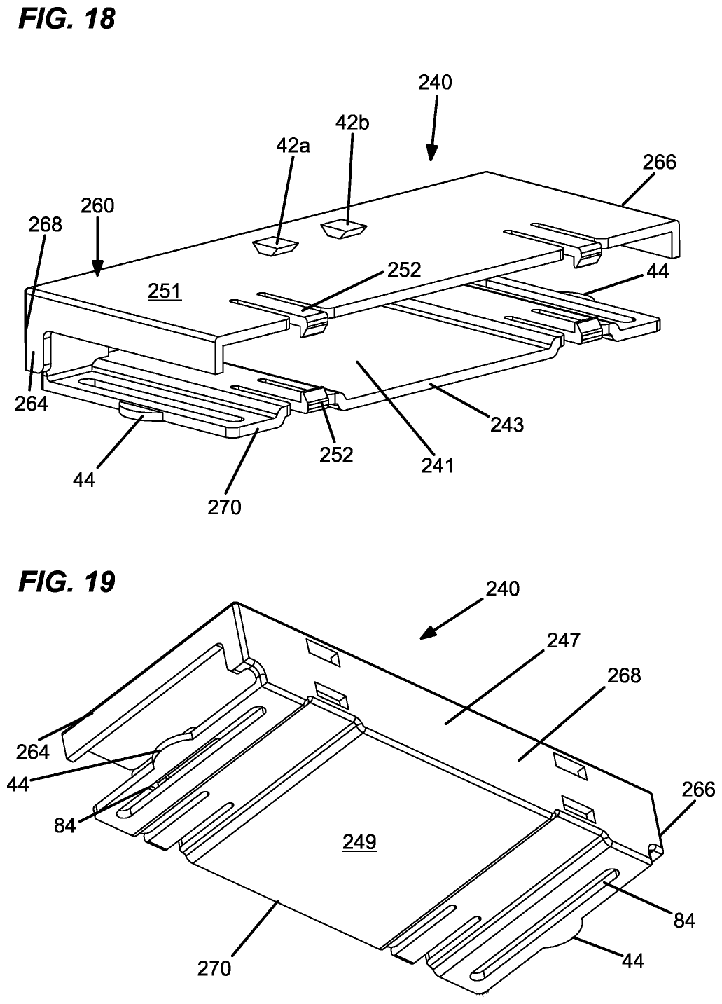

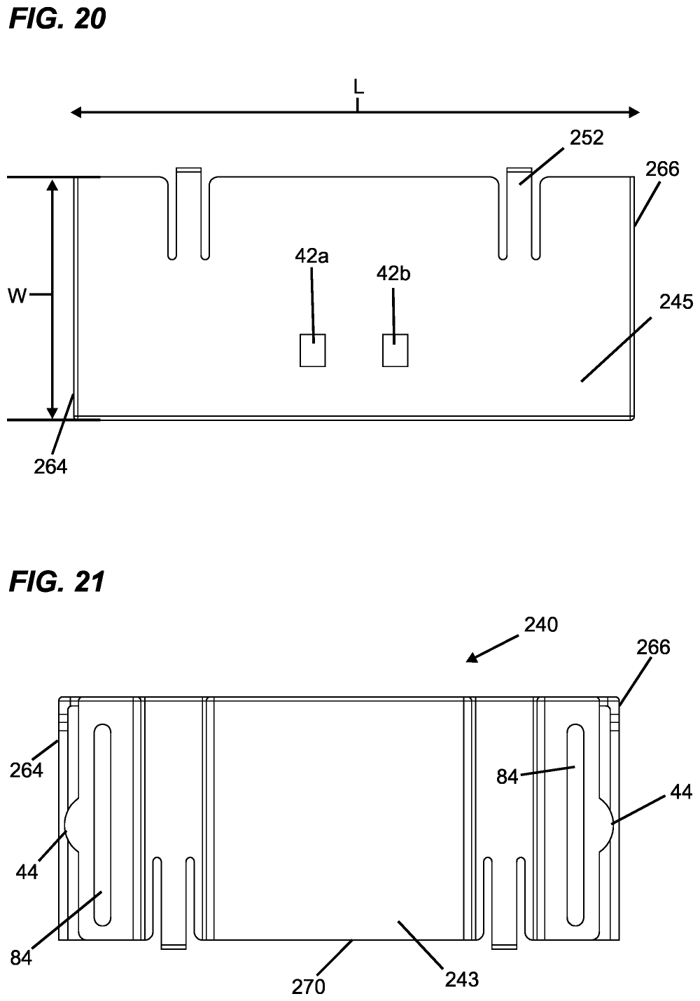

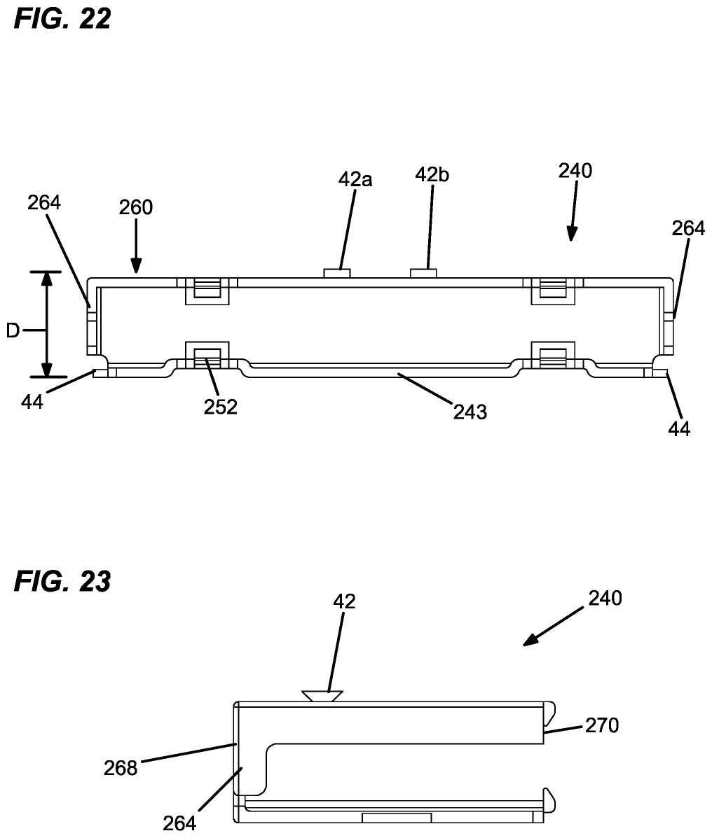

FIGS. 18-23 depict a third optical component holder 240 in accordance with the principles of the present disclosure. Similar to the previous embodiments, the optical component holder 240 includes two different types of mounting structures compatible with two different types of attachment arrangements that may be provided on a tray, panel, enclosure or other structure to which it is desired to mount the optical component holder 240. In the depicted example, one of the mounting features includes the end tabs 44 connected to end beams 84 that allow the end tabs 44 to move resiliently along a length of the optical component holder 40. A second mounting feature includes dovetail projections 42a, 42b provided at a major outer side of the optical component holder 240. The optical component holder 240 is an envelope-style holder in which optical components can be inserted laterally into a pocket 241 defined by the holder 240. Latching arms 252 are provided for retaining the optical component within the pocket 241.

The optical component holder 240 includes a holder body 260 which defines the pocket 241 at which the optical component can be secured. The holder body 260 has a length L, a width W and a depth D. The length L extends between first and second ends 264, 266 of the holder body 260. The holder body includes first and second main walls 243, 245 that oppose one another and that extend between the first and second ends 264, 266. The pocket 241 is defined at least in part between the first and second main walls 243, 245. The width W is defined between first and second sides 268, 270 of the holder body 260 that extend between the first and second ends 264, 266 of the holder body 260. The first side 268 includes a side wall 247 that interconnects the first and second main walls 243, 245. The second side 270 has an open configuration suitable for allowing the optical component to be inserted into the pocket 241 through the second side 270. The first main wall 243 defines a first major outer side 249 of the holder body 260 and the second main wall 245 defines an opposite second major outer side 251 of the holder body 260. The depth D is perpendicular with respect to the length and the width and extends between the first and second major outer sides 249, 251 of the holder body 260. The mounting tabs 44a, 44b are located at the first and second ends 264, 266 of the holder body 260 at a location adjacent the first major outer side 249. The mounting tabs 44a, 44b are resiliently movable relative to the holder body 260 along the length of the holder body 260. The dovetail projections 42a, 42b project outwardly from the second major outer side 251 of the holder body 260.

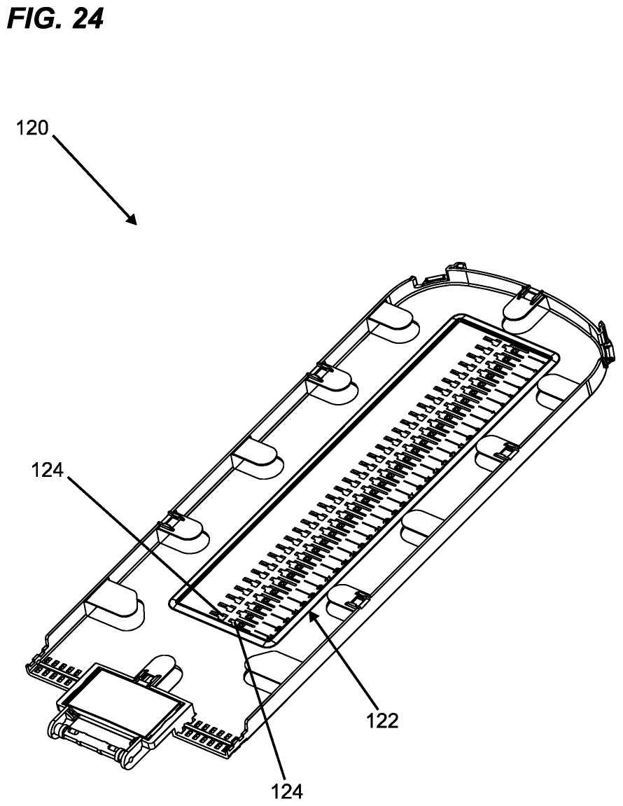

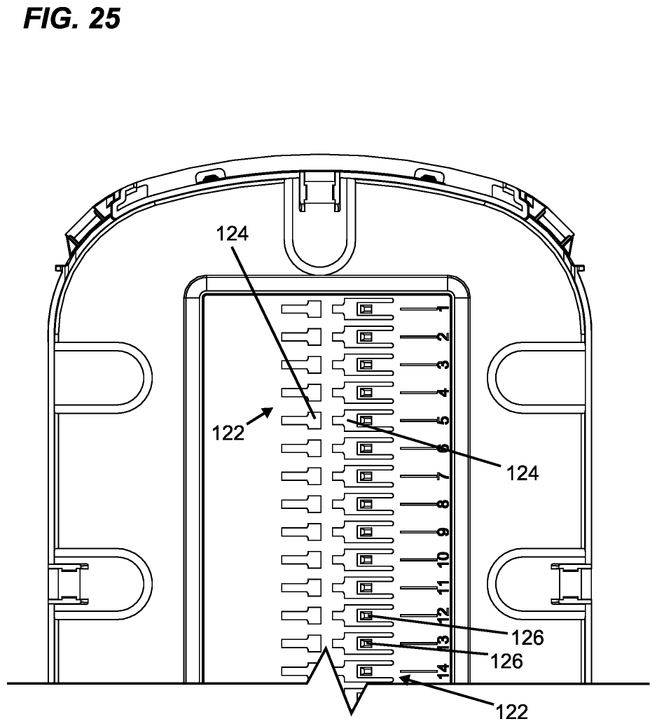

FIGS. 24 and 25 show a tray 120 having a plurality of attachment features 122 for securing component holders. The attachment features 122 each include a pair of dovetail slots 124 which have a dovetail shaped cross-section. The attachment features 122 additionally include stop receptacles 126. The attachment structures are similar to the attachment structures disclosed in PCT publication number WO2019/209643, the disclosure of which is hereby incorporated by reference.

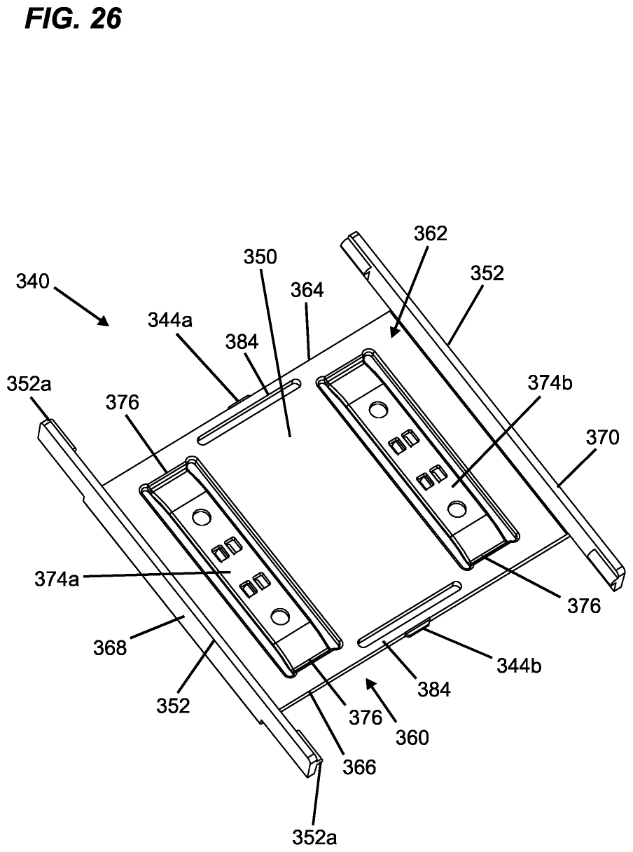

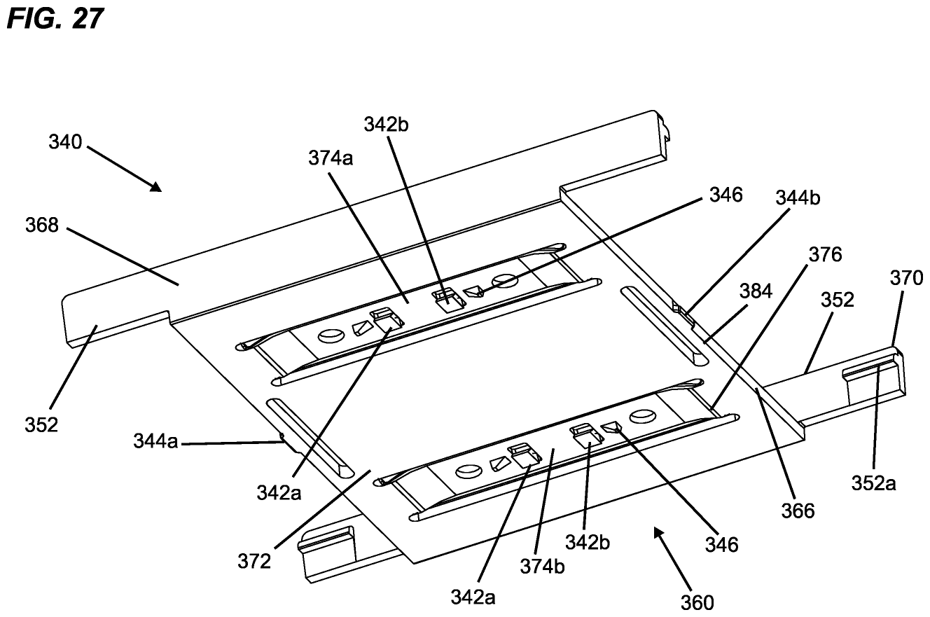

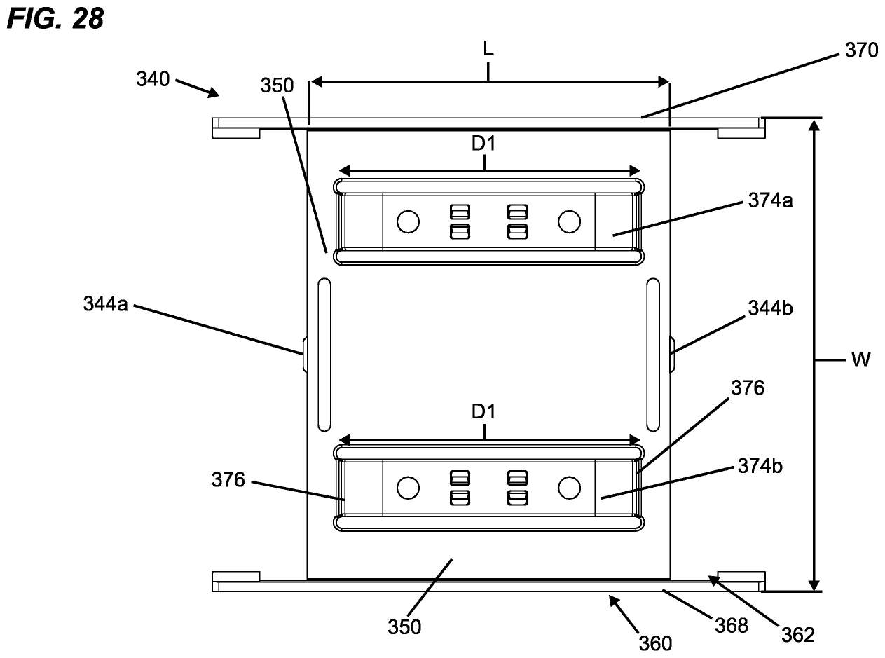

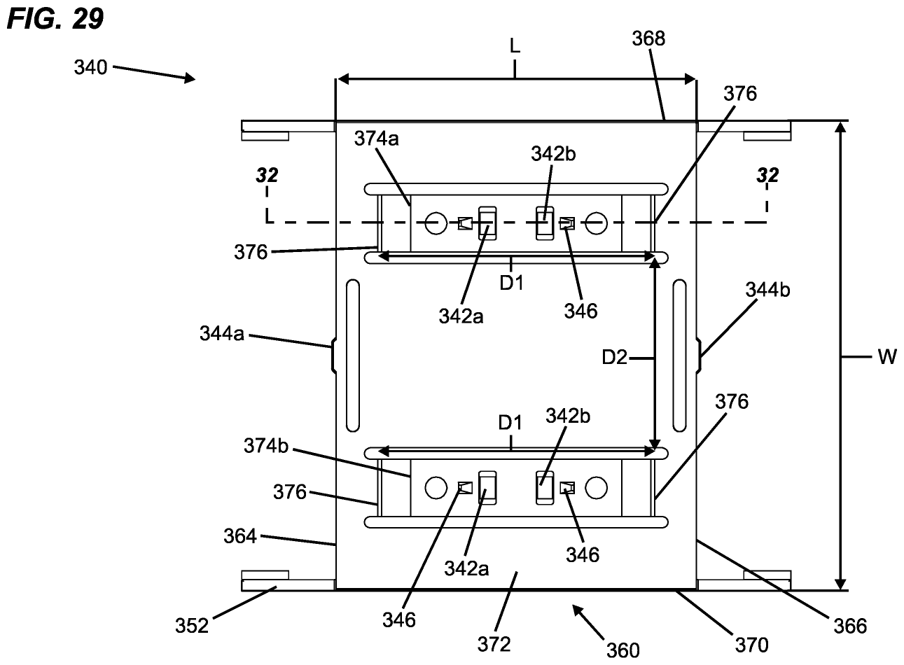

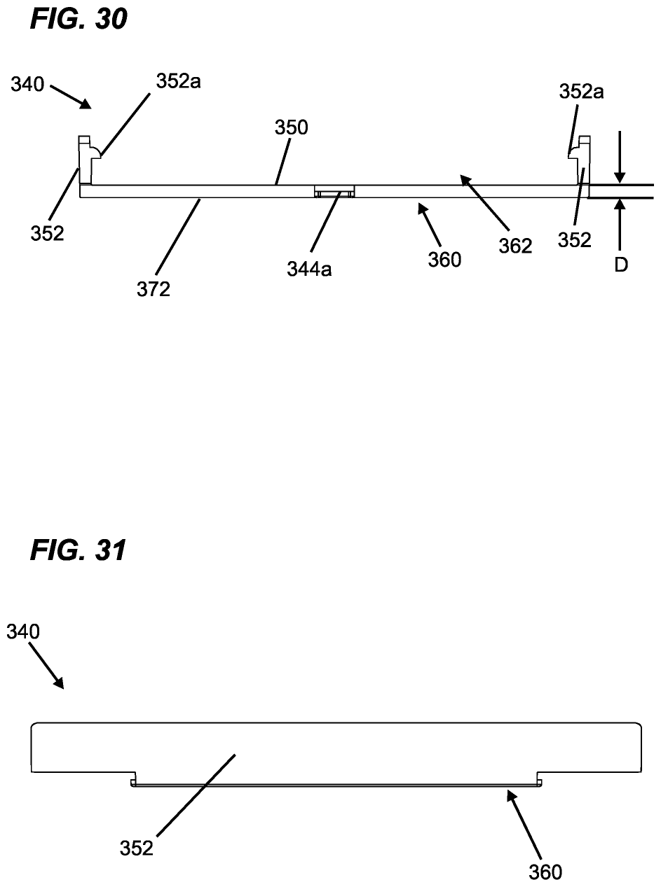

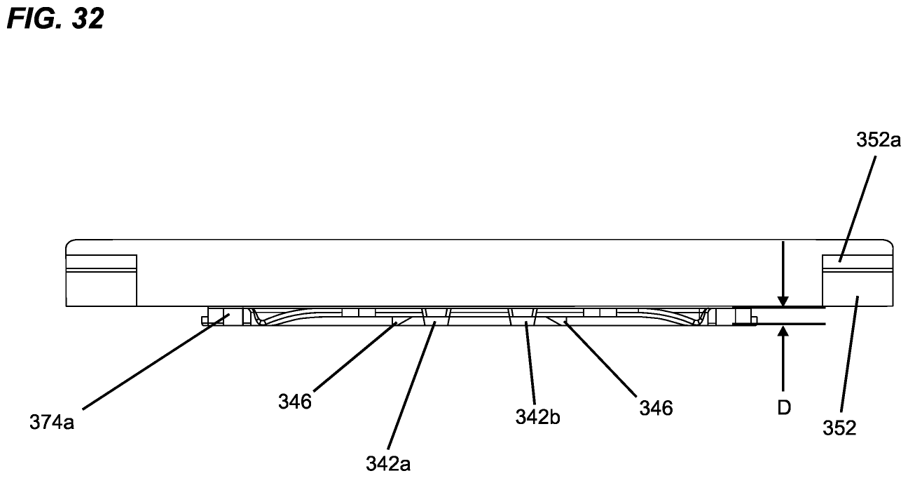

FIGS. 26-32 show a third example of an optical component holder 340 in accordance with the principles of the present disclosure. Similar to the previous embodiments, the optical component holder 340 includes two different types of mounting structures compatible with two different types of attachment features that may be provided on a tray, panel, enclosure or other structure to which it is desired to mount the optical component holder 340. The optical component holder 340 includes a holder body 360 which has a length L, a depth D and a width W. The length L extends between first and second ends 364, 366. The width W is defined between first and second sides 368, 370 of the holder body 360. The depth is perpendicular with respect to the length L and the depth D. The depth D extends between a top side 350 and a bottom side 372 of the holder body 360.

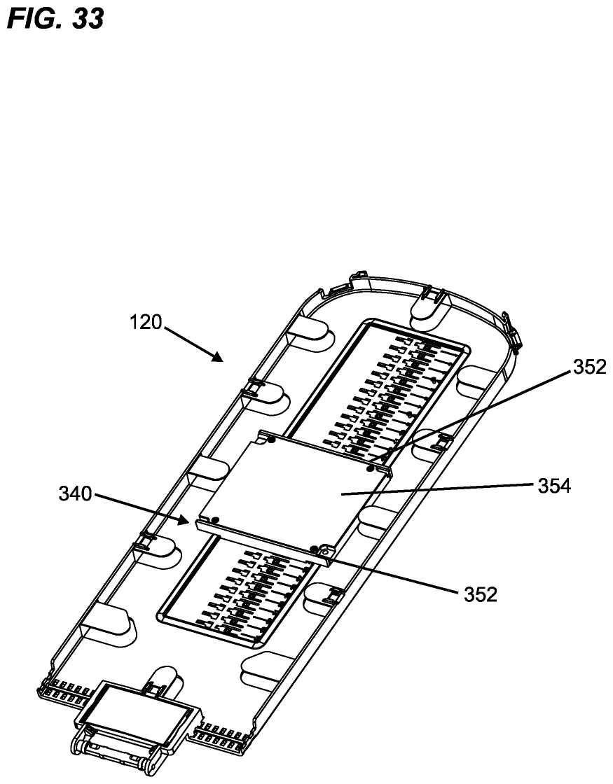

The optical component holder 340 includes first mount features depicted as first and second dovetail projections 342a, 342b and stop structures 346 that are compatible with the attachment features 122 of the tray of FIGS. 24 and 25. FIG. 33 shows the optical component holders 340 secured to the tray 120 by interlocks provided between the dovetail projections 342a, 342b of the optical component holders 340 and the dovetail slots 124 of the attachment features 122. The stop structures 346 secure within the stop receptacles 126 to prevent movement of the optical component holder 340 relative to the tray 120. The optical component holder 340 includes second mounting features depicted as end tabs 344a, 344b that are compatible with the attachment arrangements 32 of the tray 30 of FIG. 2. The end tabs 344a, 344b are located respectively at the first and second ends 364, 366. The end tabs 344a, 344b are connected to the holder by resilient end beams 384 that extend across the width W of the holder body 360.

Like the optical component holders 40, 140 discussed above, the optical component holder 340 is depicted as a plate-style holder. An optical component can be secured at the top side 350 of the optical component holder 340. In the depicted example, latching portions 352 are provided for securing an optical component to the top side 350 of the optical component holder 340. Referring to FIG. 33, an example optical component 354 is secured to the top side 350 of the optical component holder 340 by the latching portions 352. The holder body 360 includes a mounting location 362 at the top side 350 at which the optical component 354 can be secured (e.g., by the latching portions 352). The latching portions 352 extend beyond the length L of the connector body 360, thereby allowing an optical component which has a greater length than the length L of the connector body 360 to be secured thereto. In this example, the latching portions include latches 352a which allow optical components can be snap-fit into.

The optical component holder 340 includes a first and second beam members 374a, 374b. The first and second beam members 374a, 374b extend along a dimension D1 between base ends 376 along the length of the holder body 360 and are separated by a second dimension D2 along the width of the holder body 360. The first and second beam portions each include the first and second dovetail projections 342a, 342b. It will be appreciated that the beam members 374a, 374b are resilient. In some examples, the distance D2 is spaced to provide the dovetail projections 342a, 342b to attachment features on a tray such as the tray of FIGS. 24 and 25. The resilient beams 342 operate similarly to the cantilevers members 74 discussed above, explained in further detail below.

The beam members 374a, 374b are integrated with the first and second dovetail projections 342a, 342b and allow the dovetail projections 342a, 342b to be moved between an elevated and a depressed position. The resilient beams 374a, 374b are in a non-flexed (e.g., at rest state) when the dovetail projections 342a, 342b are in the elevated position, and is in a downwardly flexed state when the first and second dovetail projections 342a, 342b are in the depressed position. When the first and second dovetail projections 342a, 342b are in the elevated position, the dovetail projections 342a, 342b are situated to not interfere with the ability to secure the optical component holder 340 to the tray 30 using the end tabs 44. However, by flexing the beam members 374a, 374b downwardly to move the dovetail projections 342a, 342b to the depressed position, the dovetail projections 342a, 342b can be oriented to be readily received within the dovetail slots 124 of one of the attachment features 122 of the tray 120 to provide attachment of the optical component holder 340 to the tray 120.

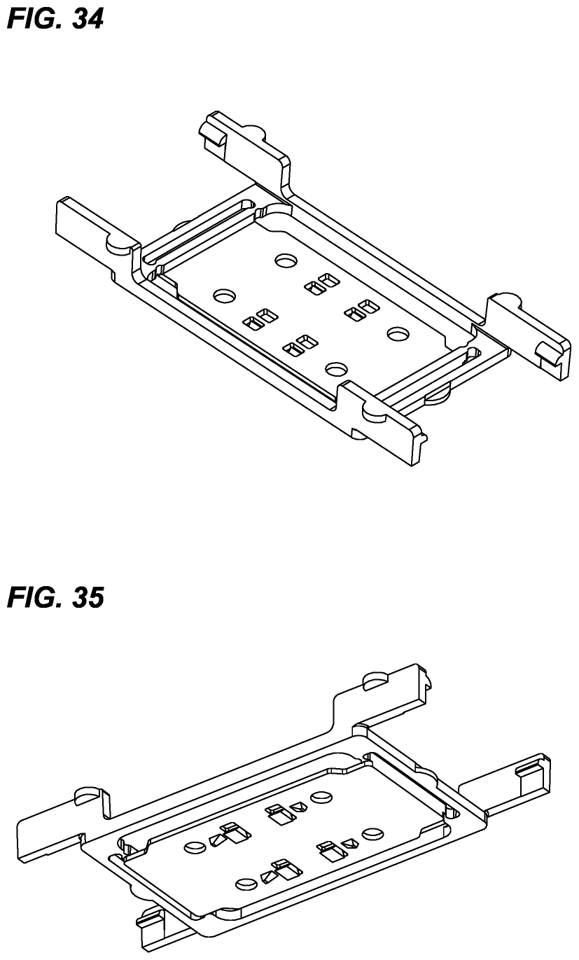

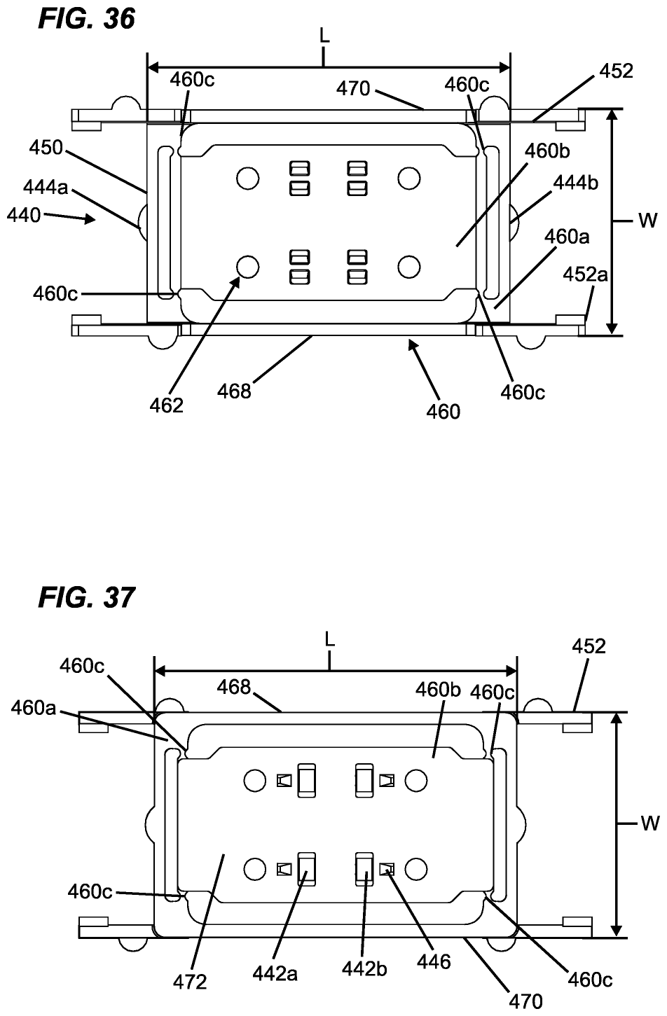

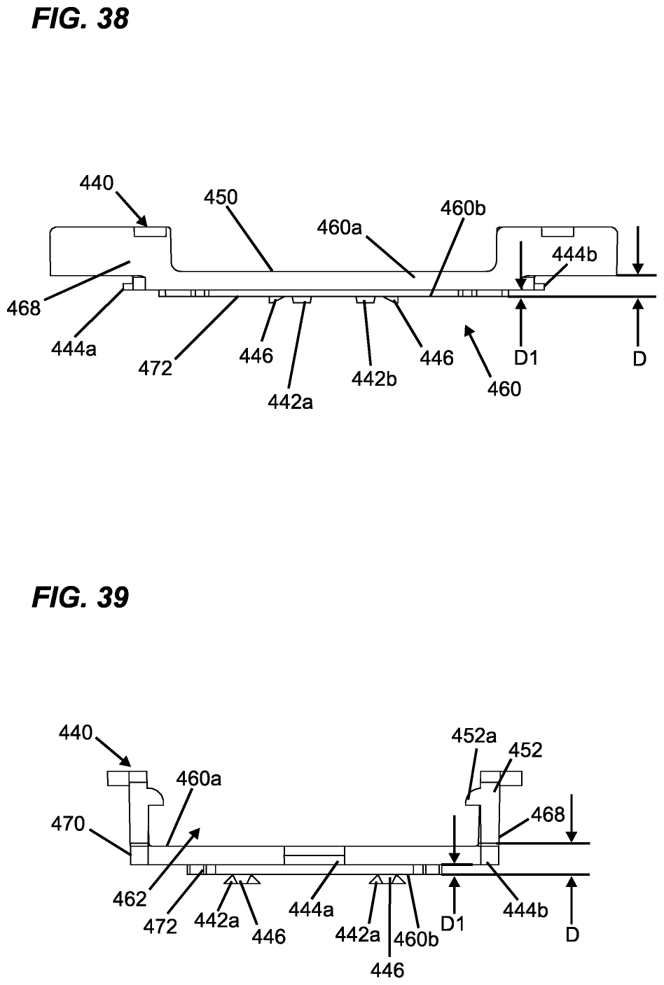

FIGS. 34-39 show a fourth example of an optical component holder 440 in accordance with the principles of the present disclosure. Similar to the previous embodiments, the optical component holder 440 includes two different types of mounting structures compatible with two different types of attachment arrangements that may be provided on a tray, panel, enclosure or other structure to which it is desired to mount the optical component holder 440. The optical component holder 440 includes a holder body 460 which has a length L, a depth D and a width W. The length L extends between first and second ends 464, 466. The width W is defined between first and second sides 468, 470 of the holder body 460. The depth is perpendicular with respect to the length L and the width W. The depth D extends between a top side 450 and a bottom side 472 of the holder body 460.

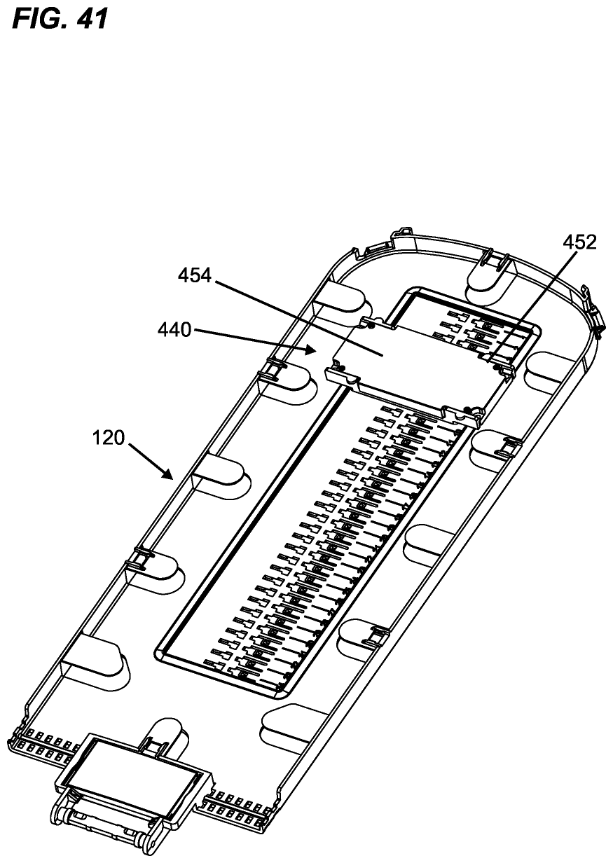

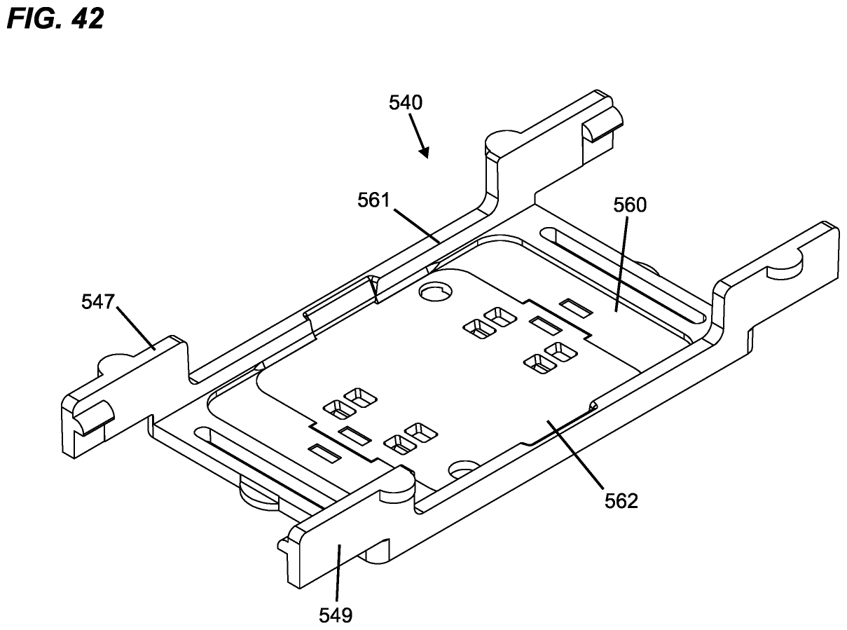

In the depicted example, one of the mounting features includes end tabs 444a, 444b connected to end beams 484 that allow the end tabs 444a, 444b at the first and second ends 464, 466 to move resiliently along a length of the optical component holder 440. A second mounting feature is located on the bottom side 472 of the holder body 460 includes dovetail projections 442a, 442b. In this particular example, there are four dovetail projections 442a, 442b. The dovetail projections 442a, 442b are compatible with the attachment features 122 of the tray 120 shown in FIGS. 24 and 25. FIG. 41 shows the optical component holders 440 secured to the tray 120 by interlocks provided between the dovetail projections 442a, 442b of the optical component holder 440 and the dovetail slots 124 of the attachment features 122. The stop structures 446 are also secured within the stop receptacles. The end tabs 444a, 444b are compatible with the attachment arrangements 32 of the tray 30 of FIG. 2. The end tabs 444a, 444b are connected to the holder by resilient end beams 484 that extend across the width W of the holder body 460.

The optical component holder 440 is a plate-style holder similar to optical component holder 40, 140, 340 and includes latching portions 452 similar to the latching portions of the optical component holder 340. An optical component can be secured at the top side 450 of the holder body 460. Referring to FIG. 41, an example optical component 454 is secured to the top side 450 of the optical component holder 440 by the latching portions 452. The holder body 460 includes a mounting location 462 at the top side 450 where the optical component 454 can be secured (e.g., by the latching portions 452). Similar to the latching portions 352, the latching portions 452 extend beyond the length L of the holder body 460, thereby allowing for an optical component which has a greater length than the length L of the holder body 460 to be connected thereto. In this example, the latching portions include latches 452a which allow optical components can be snap-fit into.

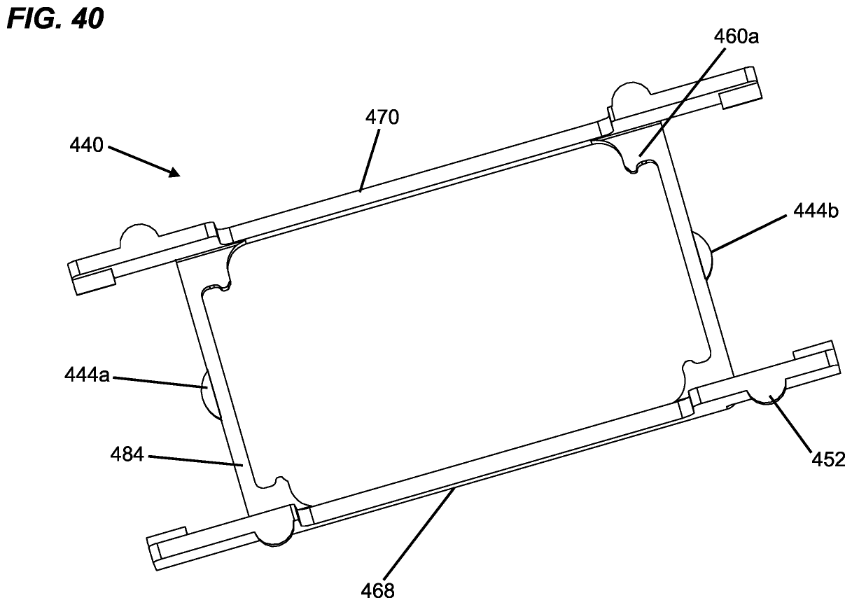

The holder body 460 includes an upper portion 460a and a lower portion 460b. The lower portion 460b is stepped downwardly from the upper portion 460a by a distance D1 along the depth D of the holder body 460. The lower portion 460b includes each of the dovetail projections 442a, 442b and is necessary to interlock with the tray 120. The lower portion 460b is attached to the upper portion 460a at corners 460c. The end tabs 444a, 444b are attached at the upper portion 460a. As the end tabs 444a, 444b are positioned upwardly from the lower portion 460b, the lower portion interferes with use of the end tabs when the end tabs are used to mount with a tray having features similar to the tray 30. To use the end tabs 444a, 444b for mounting with the tray 30, the lower portion 460b is removable. The corners 460c can be removed, for example cut, in order to remove the lower portion 460b. FIG. 40 shows the optical component holder 440 with the lower portion 460b removed.

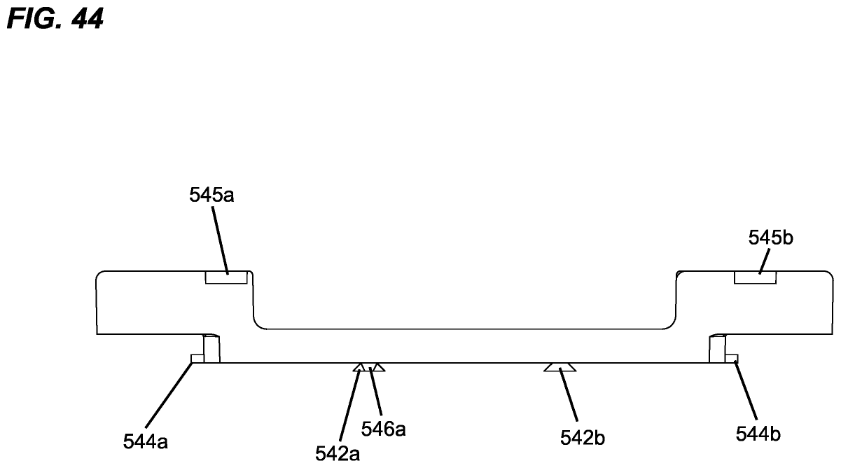

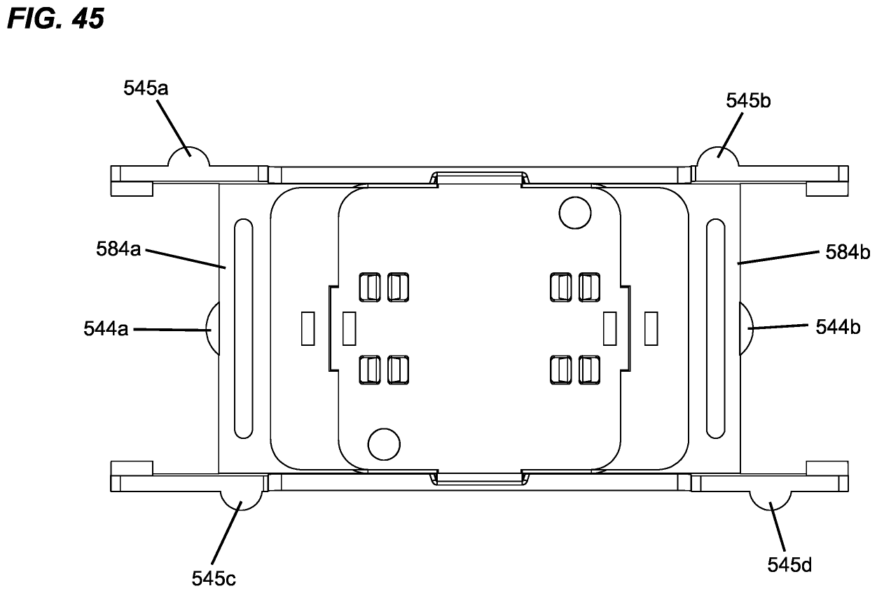

FIGS. 42-47 and 48-50 respectively show a fifth and sixth example of an optical component holder 540, 640 in accordance with the principles of the present disclosure. Similar to the previous embodiments, the optical component holder 540, 640 includes two different types of mounting structures compatible with two different types of attachment arrangements that may be provided on a tray, panel, enclosure or other structure to which it is desired to mount the optical component holder 540, 640. In embodiments, the optical component holder 540 includes a holder body 560, 660 including an upper portion 561, 661 defining a first mounting feature, and a lower portion 562, 662 (occasionally referred to as an “rotation dovetail plate”) defining a second mounting feature, such that the optical component holder 540, 640 can be operably coupled to a tray with either of the first mounting feature or the second mounting feature. In cases where the optical component holder 540, 640 is mounted to the tray with the second mounting feature, the rotation dovetail plate 562, 662 may be inserted into an aperture defined by the holder body 560, 660. In cases where the optical component holder 540, 640 is mounted to the tray with the first mounting feature, inclusion of the rotation dovetail plate 562, 662 may be omitted.

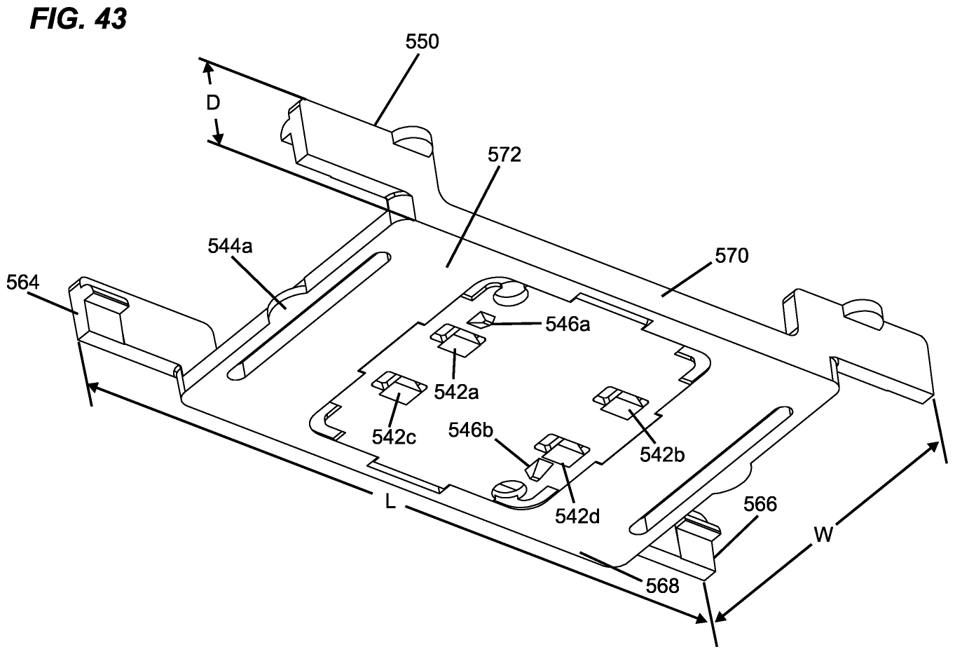

As best depicted in FIG. 43, the holder body 560 has a length L, a width W, and a depth D. The length L extends between first and second ends 564, 566 of the holder body 560. The width is defined between first and second sides 568, 570 of the holder body 560. The depth D is perpendicular with respect to the length L and the width W, and extends between a top side 550 and a bottom side 572 of the holder body 560. In some embodiments, the lower portion 562 can be stepped downwardly from the upper portion 561 by a predetermined distance along a depth D of the holder body 560. In other embodiments, such as that depicted in FIGS. 42-47 and 48-50 the bottom side 572 of both the upper portion 561 and the lower portion 562 can be substantially coplanar, with the second mounting features extending below the bottom side 572 of the lower portion 562.

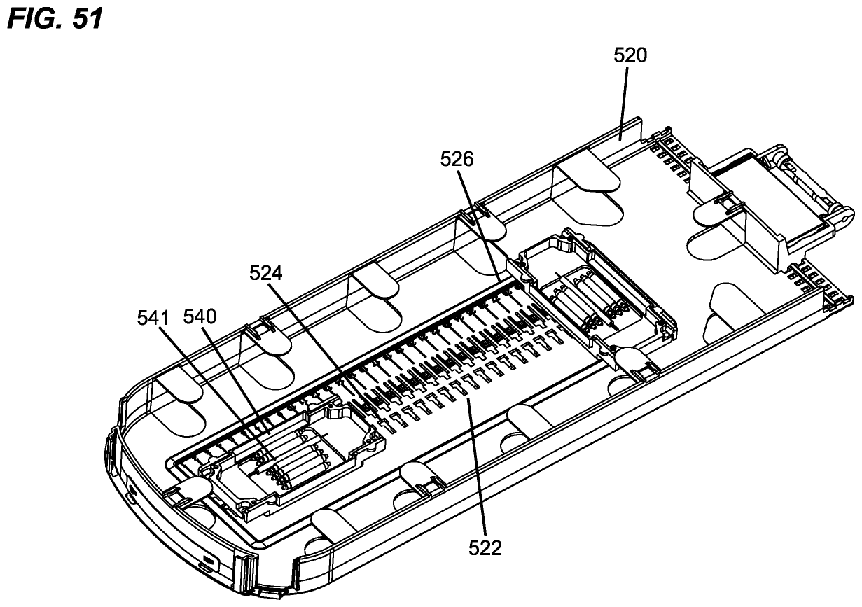

The upper portion 561 can define one or more first mounting features. For example, in some embodiments, the one or more first mounting features can include end tabs 544a, 544b connected to respective end beams 584a, 584b configured to enable the end tabs 544a, 544b to resiliently move or flex along the length L of the optical component holder 540. In embodiments, the end tabs 544a, 544b are compatible with attachment features 522 of tray 520, as shown in FIG. 51. For example, in one embodiment, one or more optical component holders 540 can be secured to the tray 520 by interlocks provided between the end tabs 544a, 544b of the optical component holder 540 and one or more apertures 526 of the attachment features 522. In embodiments, the end tabs 544a, 544b are operably coupled to the holder body 560 by resilient end beams 584a, 584b, that generally extend across the width W of the holder body 560 configured to enable the end tabs 544a, 544b to temporarily flex inwardly toward an interior of the holder body 560 while coupling to the tray 520.

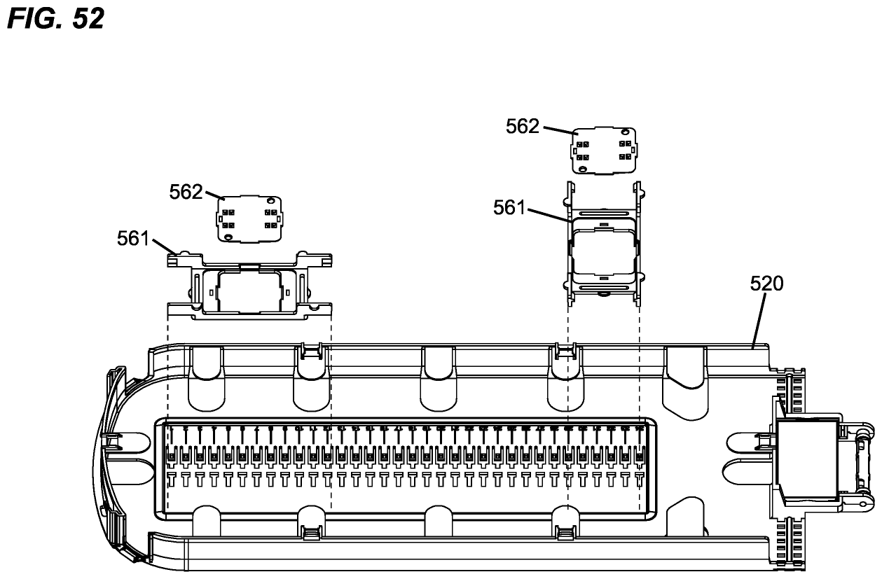

The lower portion 562 can define one or more second mounting features. For example, in some embodiments, the one or more second mounting features can include dovetail projections 542a, 542b, 542c, 542d which can extend beyond the bottom side 572 of the holder body 560. In this particular example, there are four dovetail projections 542a-d. The dovetail projections 542a-d are compatible with the attachment features 522 of the tray 520 shown in FIGS. 51-52. For example, in one embodiment, one or more optical component holders 540 can be secured to the tray 520 by interlocks provided between the dovetail projections 542a-d of the optical component holder 540 and the dovetail slots 524 of the attachment features 522. In some embodiments, one or more stop structures 546a, 546b can aid in securing the optical component holder 540 within the attachment features 522 of the tray 520.

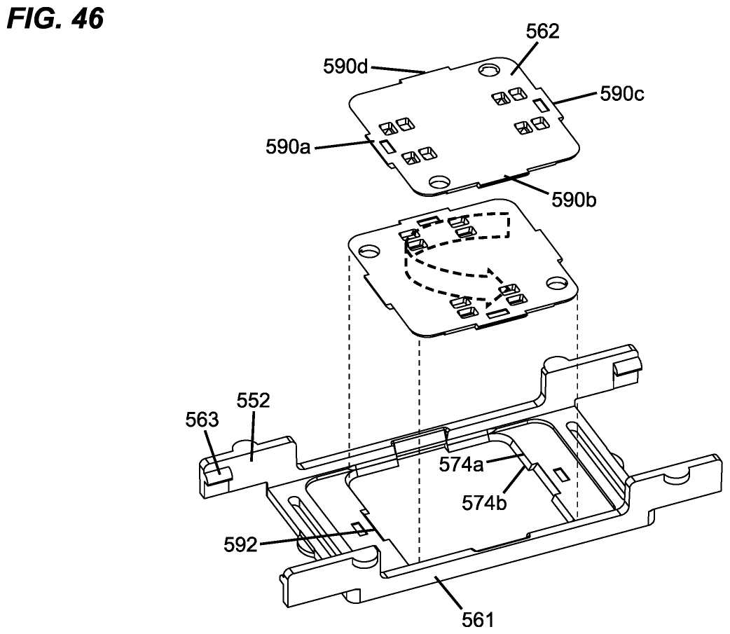

As best depicted in FIG. 46, in some embodiments, the lower portion 562 can be selectively mountable to the upper portion 561, thereby enabling the optical component holder 540 to be operably coupled to a tray 520 with the one or more secondary mounting features. For example, in one embodiment, the upper portion 561 can define an aperture 574 configured to selectively receive the lower portion 562. Conversely, if it is desired to mount the optical component holder 540 to the tray 520 with the first mounting features, use of the lower portion 562 can be omitted, such that the aperture 574 of the holder body 560 remains in an open configuration to inhibit interference between the dovetail projections 542a-d and the tray 520, when the end tabs 544a, 544b are inserted into the apertures 526 of the attachment feature 522.

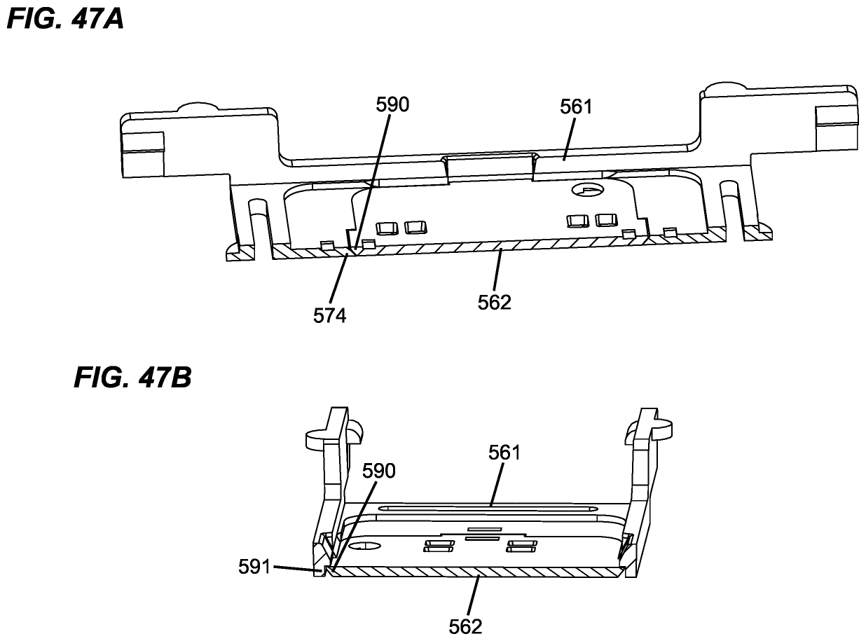

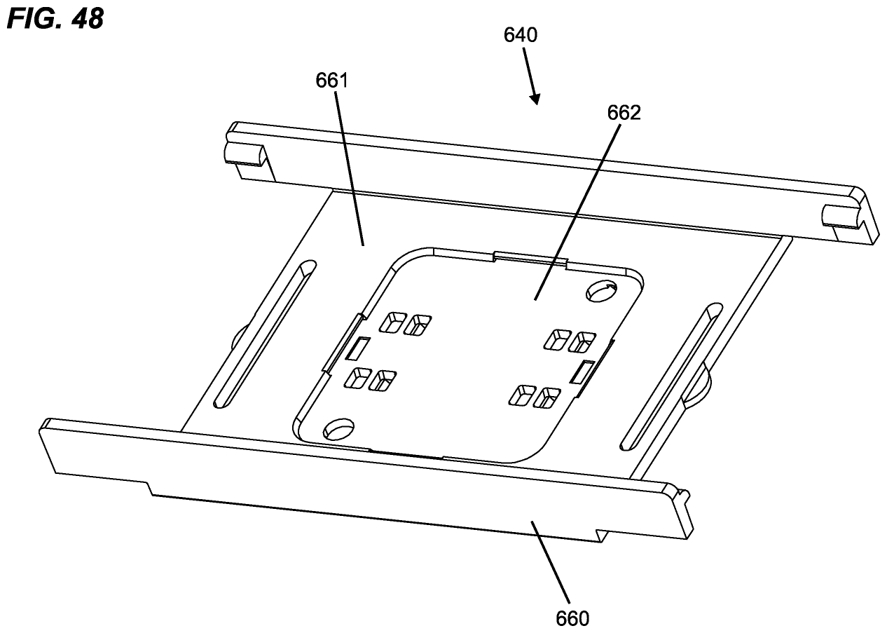

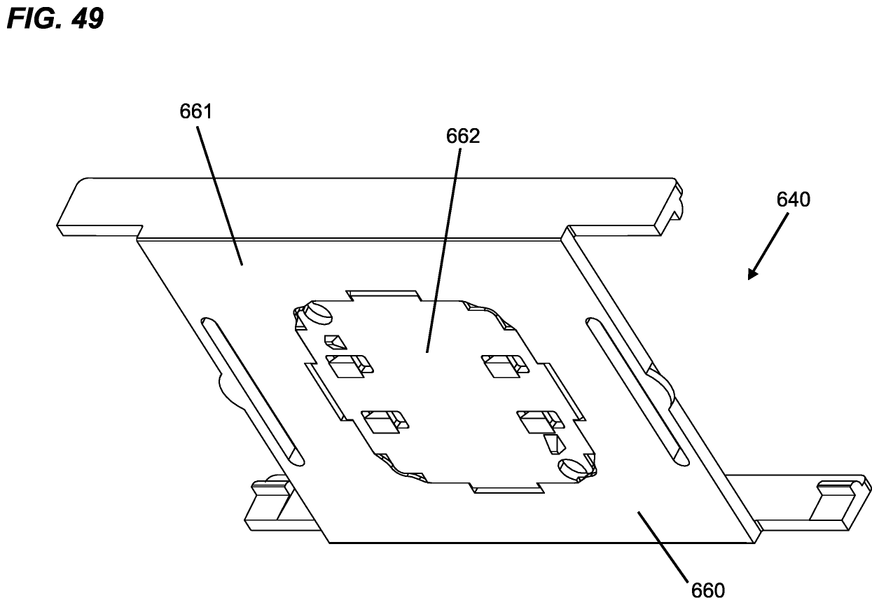

To facilitate coupling of the lower portion 562 to the upper portion 561, in some embodiments, the lower portion 562 can define one or more tabs 590a-d configured to mate with one or more corresponding receptacles 592 defined by the aperture 574. For example, as depicted in FIG. 47A, the one or more tabs 590a-d can be beveled, angled, or otherwise keyed such that the lower portion 562 may only be inserted into a top of the aperture 574 (i.e., a top perimeter of the aperture 574a is larger than a bottom perimeter of the aperture 574b), such that the lower portion 562 cannot pass entirely through the aperture 574. In this manner, coupling of the dovetail projections 542a-d of the lower portion 562 to the tray 520 causes the one or more tabs 590 to retain the upper portion 561 in position relative to the tray 520. Further, as depicted in FIG. 47B, one or more of the tabs 590a-d can snap fit into a receptacle 591 defined by the aperture 574, thereby securing the lower portion 562 to the upper portion 561, by inhibiting the lower portion 562 from lifting out of the aperture 574.

Further, in some embodiments, the lower portion 562 can be configured such that it can be inserted in multiple orientations with respect to the aperture 574. For example, in one embodiment, the lower portion 562 can include four uniformly sized tabs 590a-d positioned on respective equal length sides of the lower portion 562, such that the lower portion 562 can be secured relative to the upper portion 561 in 90 degree increments, thereby enabling the optical component holder 540 to be coupled to the tray 520 in at least one of a first orientation, or a second orientation substantially perpendicular to the first orientation.

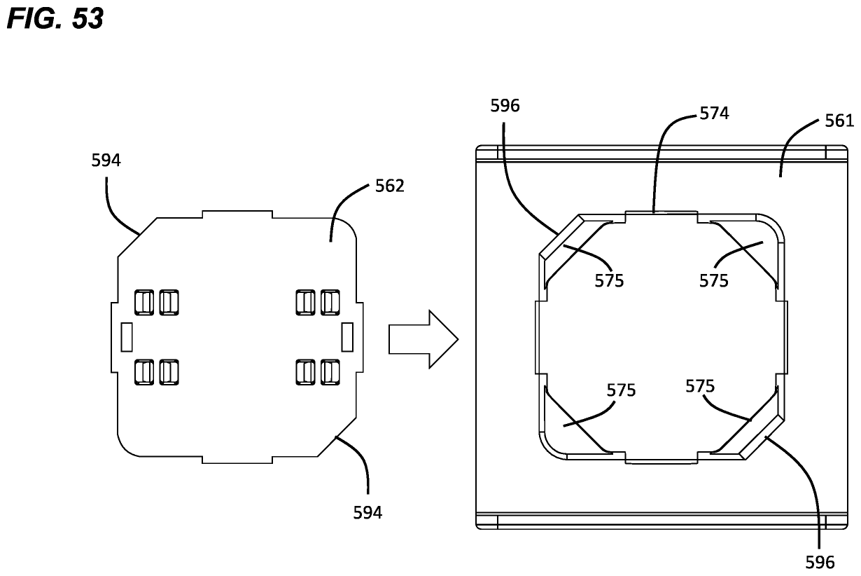

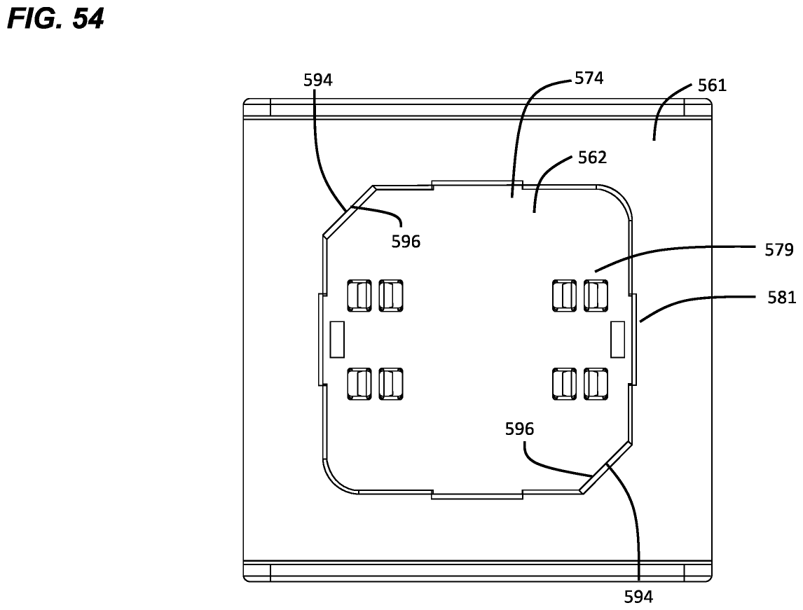

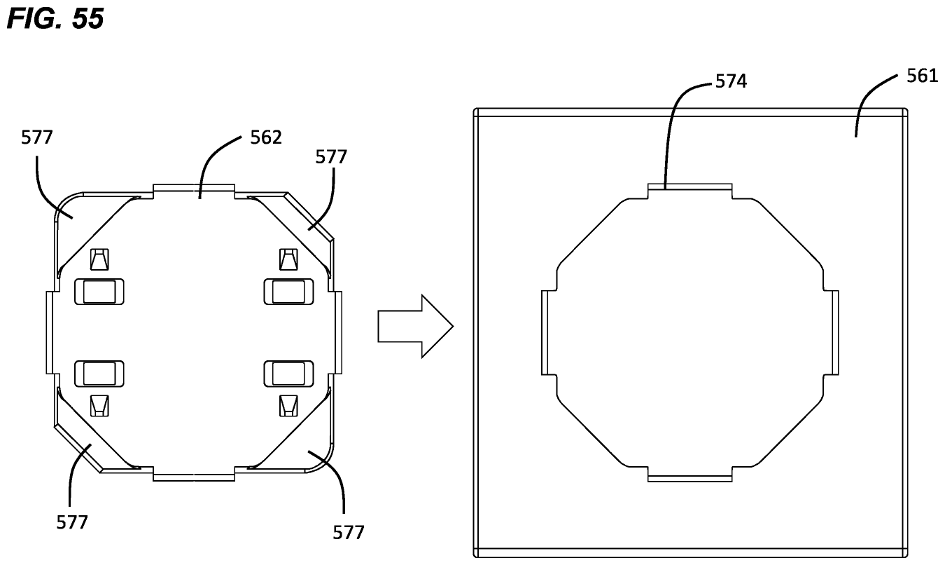

Referring to FIGS. 53-54, certain embodiments include a keying mechanism that limits the mounting of the lower portion 562 or aperture 574 in specific orientations relative to the upper portion 561. For instance, in one embodiment, the lower portion 562 can have chamfered corners 594, while the aperture 574 can have chamfered corners 596 that correspond to the chamfered corners 594, thereby restricting the orientation of the lower portion 562 to a 180° pair of orientations. This configuration ensures that the chamfered corners 594 are aligned with the chamfered corners 596 (as shown in FIG. 54). In other embodiments, different portions of the lower portion 562 or aperture 574 can be keyed to limit the mounting of the lower portion 562 to one or more orientations relative to the upper portion 561. Additionally, in some embodiments, webbing 575 can be present at one or more corners of the aperture 574 to prevent the upper portion 561 from passing completely through the aperture 574. Moreover, corresponding relief portions 577 (as shown in FIG. 55) can be defined in the upper portion 561 to allow flush mounting of a top surface 579 of the lower portion 562 with a top surface 581 of the upper portion 561.

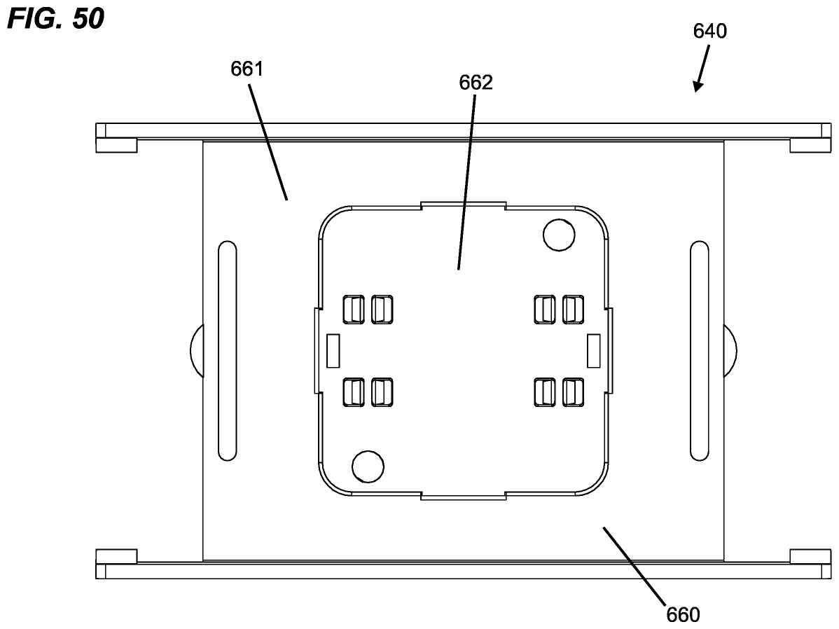

The optical component holder 540, 640 can be in the form of a plate-style holder similar to optical component holders 40, 140, 340, 440, which can include latching portions 552 similar to the latching portions of the optical component holder 340, 440. As depicted in FIG. 51, one or more optical components 541 can be secured at the top side 550 of the optical component holder 540. Alternatively, the optical component can secured to the top side 550 of the optical component holder 540 by the latching portions 552, which can include latches 563 (as better depicted in FIGS. 46 and 48) which enable optical components can be snap-fit coupled to the holder body 560. For improved cable management, as depicted in FIGS. 42-47, in some embodiments, the upper portion 561 can define one or more arms 547, 549 generally extending upwardly from the bottom side 572, which can define one or more cable retention features 545a-d.

From the foregoing detailed description, it will be evident that modifications and variations can be made in the devices and methods of the disclosure without departing from the spirit or scope of the invention.

1. A holder for an optical component, the holder comprising:
a holder body including a mounting location at which the optical component can be secured, the holder body having a length, a width and a depth, the length extending between first and second ends of the holder body, the holder body including first and second sides that extend between the first and second ends of the holder body, the width being defined between the first and second sides of the holder body, and the depth being perpendicular with respect to the length and the width;
first and second mounting tabs located at the first and second ends, the first and second mounting tabs being resiliently moveable relative to the holder body in a first orientation along the length of the holder body;
first and second dovetail projections projecting outwardly relative to the holder body in a second orientation along the depth of the holder body;
wherein the holder body includes an upper and a lower portion, the lower portion being stepped downward from the upper portion by a distance along the depth of the holder body;
wherein the first and second dovetail projections are integrated with the lower portion and the first and second mounting tabs are integrated with the upper portion.

2. The holder of claim 1, wherein the lower portion is removable from the upper portion.

3. The holder of claim 1, wherein the lower portion is attached to the upper portion with snaps.

4. The holder of claim 1, wherein the lower portion is removable from the upper portion by cutting.

5. The holder of claim 3, further comprising a tray, wherein the holder body is mountable to the tray in at least two orientations, including a first orientation and a second orientation generally perpendicular relative to the first orientation.

6. A holder for an optical component, comprising:
a holder body including one or more first mounting features for selective securement of the holder body to an optical tray and a mounting location at which the optical component can be secured, the holder body further defining an aperture; and
a rotation dovetail plate including one or more second mounting features for selective securement of the rotation dovetail plate to an optical tray, wherein the rotation dovetail plate is keyed to reside within the aperture of the holder body in one of at least a first orientation and a second orientation, wherein the first orientation is substantially perpendicular to the second orientation.

7. The holder for an optical component of claim 6, wherein a top perimeter of the aperture of the holder body is larger than a bottom perimeter of the aperture body to inhibit passage of the rotation dovetail plate entirely through the aperture.

8. The holder for an optical component of claim 6, wherein the rotation dovetail plate is selectively securable to the upper portion with one or more snaps.

9. The holder for an optical component of claim 6, wherein the one or more first mounting features are in the form of at least one or more semicircular or curved tabs.

10. The holder for an optical component of claim 6, wherein the one or more first mounting features are operably coupled to respective end beams to enable the one or more first mounting features to resiliently flex relative to other portions of the holder body.

11. The holder for an optical component of claim 6, wherein the one or more second mounting features are in the form of one or more dovetail projections extending from a bottom side of the rotation dovetail plate.

12. The holder for an optical component of claim 10, wherein the rotation dovetail plate further defines one or more stop structures to aid in securing of the rotation dovetail plate to a tray.

13. The holder for an optical component of claim 6, wherein the rotation dovetail plate includes at least four perpendicular sides substantially equal in length, with at least two of the sides defining keyed tabs configured to reside within the aperture of the holder body.

14. The holder for an optical component of claim 6, wherein the holder body further defines a latching portion for selective coupling to an optical component.

15. The holder for an optical component of claim 6, wherein at least one of the holder body or the rotation dovetail plate define one or more chamfered surfaces configured to restrict securement of the rotation dovetail plate relative to the holder body to one or more orientations.

16. An assembly for securement of an optical component, comprising:
a tray selectively couplable to a housing;
a holder body including one or more first mounting features for selective securement of the holder body to the tray and a mounting location at which the optical component can be secured, the holder body further defining an aperture; and
a rotation dovetail plate including one or more second mounting features for selective securement of the rotation dovetail plate to an optical tray, wherein the rotation dovetail plate is keyed to reside within the aperture of the holder body in one of at least a first orientation and a second orientation, wherein the first orientation is substantially perpendicular to the second orientation.

17. The assembly of claim 16, wherein a top perimeter of the aperture of the holder body is larger than a bottom perimeter of the aperture body to inhibit passage of the rotation dovetail plate entirely through the aperture.

18. The assembly of claim 16, wherein the rotation dovetail plate is selectively securable to the upper portion with one or more snaps.

19. The assembly of claim 16, wherein the one or more first mounting features are in the form of one or more semicircular or curved tabs.

20. The assembly of claim 16, wherein the one or more second mounting features are in the form of one or more dovetail projections extending from a bottom side of the rotation dovetail plate.

21. The assembly of claim 16, wherein the rotation dovetail plate includes at least four perpendicular sides substantially equal in length, with at least two of the sides defining keyed tabs configured to reside within the aperture of the holder body.

22. The assembly of claim 16, wherein at least one of the holder body or the rotation dovetail plate define one or more chamfered surfaces configured to restrict securement of the rotation dovetail plate relative to the holder body to one or more orientations.
